(19) United States
(12) Patent Application Publication
(10) Pub. No.: US 2026/0271014 A1
(43) Pub. Date: Sep. 10, 2026

(54) ARTIFICIAL INTELLIGENCE (AI)/MACHINE LEARNING (ML) FOR CSI FEEDBACK ENHANCEMENT

(71) Applicant: Sharp Kabushiki Kaisha, Sakai City, Osaka (JP)

(72) Inventors: ZHANPING YIN, Vancouver, WA (US); KAI YING, Vancouver, WA (US); TOMOKI YOSHIMURA, Sakai City, Osaka (JP)

(21) Appl. No.: 19/101,715

(22) PCT Filed: Aug. 30, 2023
(86) PCT No.: PCT/JP2023/031583

§ 371 Date: Feb. 6, 2025

Related U.S. Application Data
(60) Provisional application No. 63/409,665, filed on Sep. 23, 2022.

(51) Int. Cl. H04W 72/232; H04L 41/16

(52) U.S. Cl. CPC H04W 72/232; H04L 41/16

(57) ABSTRACT

A user equipment (UE) is described. The UE may include receiving circuitry configured to receive on a first physical downlink control channel (PDCCH), a first downlink control information (DCI) format used for indicating a first Artificial Intelligence (AI)/Machine Learning (ML) model with a first index. The UE may also include receiving circuitry configured to receive on a PDCCH a second DCI format used for indicating a second AI/ML model with a second index. The UE may also include processing circuitry configured to perform the first AI/ML model or the second AI/ML model based on the first index and the second index in a case that the first AI/ML model overlaps with the second AI/ML model on a predefined AI/ML model unit(s).

### CROSS REFERENCE

This Nonprovisional application claims priority under 35 U.S.C. § 119 on provisional Application No. 63/409,665 on Sep. 23, 2022, the entire contents of which are hereby incorporated by reference.

### TECHNICAL FIELD

The present disclosure relates generally to communication systems. More specifically, the present disclosure relates to Artificial Intelligence (AI)/Machine Learning (ML) for CSI feedback enhancement.

### BACKGROUND ART

Wireless communication devices have become smaller and more powerful in order to meet consumer needs and to improve portability and convenience. Consumers have become dependent upon wireless communication devices and have come to expect reliable service, expanded areas of coverage and increased functionality. A wireless communication system may provide communication for a number of wireless communication devices, each of which may be serviced by a base station. A base station may be a device that communicates with wireless communication devices.

As wireless communication devices have advanced, improvements in communication capacity, speed, flexibility and/or efficiency have been sought. However, improving communication capacity, speed, flexibility and/or efficiency may present certain problems.

For example, wireless communication devices may communicate with one or more devices using a communication structure. However, the communication structure used may only offer limited flexibility and/or efficiency. As illustrated by this discussion, systems and methods that improve communication flexibility and/or efficiency may be beneficial.

### SUMMARY OF INVENTION

In one example, a user equipment (UE) comprises receiving circuitry configured to receive on a first physical downlink control channel (PDCCH), a first downlink control information (DCI) format used for indicating a first Artificial Intelligence (AI)/Machine Learning (ML) model with a first index, receiving circuitry configured to receive on a PDCCH a second DCI format used for indicating a second AI/ML model with a second index, and processing circuitry configured to perform the first AI/ML model or the second AI/ML model based on the first index and the second index in a case that the first AI/ML model overlaps with the second AI/ML model on a predefined AI/ML model unit(s).

In one example, a base station apparatus comprises: transmitting circuitry configured to transmit on a first physical downlink control channel (PDCCH), a first downlink control information (DCI) format used for indicating a first Artificial Intelligence (AI)/Machine Learning (ML) model with a first index, and transmitting circuitry configured to transmit on a PDCCH a second DCI format used for indicating a second AI/ML model with a second index.

In one example, a communication method of a user equipment comprises: receiving on a first physical downlink control channel (PDCCH), a first downlink control information (DCI) format used for indicating a first Artificial Intelligence (AI)/Machine Learning (ML) model with a first index, receiving on a PDCCH a second DCI format used for indicating a second AI/ML model with a second index, and performing the first AI/ML model or the second AI/ML model based on the first index and the second index in a case that the first AI/ML model overlaps with the second AI/ML model on a predefined AI/ML model unit(s).

### BRIEF DESCRIPTION OF DRAWINGS

FIG. 1 is a block diagram illustrating one implementation of one or more g Node Bs (gNBs) and one or more user equipment (UEs) in which systems and methods for signaling may be implemented;

FIG. 2 shows examples of multiple numerologies;

FIG. 3 is a diagram illustrating one example of a resource grid and resource block;

FIG. 4 shows examples of resource regions;

FIG. 5 illustrates an example of beamforming and quasi-colocation (QCL) type;

FIG. 6 illustrates an example of transmission configuration indication (TCI) states;

FIG. 7 is a block diagram illustrating one implementation of a UE;

FIG. 8 is a flow diagram illustrating one example of a communication method of a UE;

FIG. 9 is a flow diagram illustrating one example of a communication method of a UE;

FIG. 10 is a flow diagram illustrating one example of a communication method of a UE;

FIG. 11 illustrates various components that may be utilized in a UE;

FIG. 12 illustrates various components that may be utilized in a gNB;

FIG. 13 is a block diagram illustrating one implementation of a UE in which one or more of the systems and/or methods described herein may be implemented;

FIG. 14 is a block diagram illustrating one implementation of a gNB in which one or more of the systems and/or methods described herein may be implemented;

FIG. 15 is a block diagram illustrating one implementation of a gNB; and

FIG. 16 is a block diagram illustrating one implementation of a UE.

### DESCRIPTION OF EMBODIMENTS

A user equipment (UE) is described. The UE may include receiving circuitry configured to receive on a first physical downlink control channel (PDCCH), a first downlink control information (DCI) format used for indicating a first Artificial Intelligence (AI)/Machine Learning (ML) model with a first index. The UE may also include receiving circuitry configured to receive on a physical downlink control channel (PDCCH), a second downlink control information (DCI) format used for indicating a second Artificial Intelligence (AI)/Machine Learning (ML) model with a second index. The UE may also include processing circuitry configured to perform the first AI/ML model or the second AI/ML model based on the first index and the second index in a case that the first AI/ML model overlaps with the second AI/ML model on a predefined AI/ML model unit(s).

In some examples, the receiving circuitry of the UE includes receiving a radio resource control (RRC) message comprising first information used for indicating a maximum number of the predefined AI/ML model unit(s).

The first index of the UE may be determined by a first use case where the first AI/ML model is applied and the second index is determined by a second use case where the second AI/ML model is applied. In some examples, the first index may be determined by a first set of parameters within the first AI/ML model and the second index may be determined by a second set of parameters within the second AI/ML model. In further examples, the first index of the UE may be determined by a first size of the first AI/ML model and the second index may be determined by a second size of the second AI/ML model.

A base station apparatus is described. The base station apparatus may include transmitting circuitry configured to transmit on a first physical downlink control channel (PDCCH), a first downlink control information (DCI) format used for indicating a first Artificial Intelligence (AI)/Machine Learning (ML) model with a first index. The base station apparatus may also include transmitting circuitry configured to transmit on a physical downlink control channel (PDCCH), a second downlink control information (DCI) format used for indicating a second Artificial Intelligence (AI)/Machine Learning (ML) model with a second index.

The transmitting circuitry of the base station may be configured to transmit a radio resource control (RRC) message comprising first information used for indicating a maximum number of the predefined AI/ML model unit(s).

In some examples, the first index may be determined by a first use case where the first AI/ML model is applied and the second index may be determined by a second use case where the second AI/ML model is applied. In further examples, the first index may be determined by a first set of parameters within the first AI/ML model and the second index may be determined by a second set of parameters within the second AI/ML model. The first index may also be determined by a first size of the first AI/ML model and the second index may be determined by a second size of the second AI/ML model.

A communication method of a user equipment is described. The method may include receiving on a first physical downlink control channel (PDCCH), a first downlink control information (DCI) format used for indicating a first Artificial Intelligence (AI)/Machine Learning (ML) model with a first index. The method may also include receiving on a physical downlink control channel (PDCCH), a second downlink control information (DCI) format used for indicating a second Artificial Intelligence (AI)/Machine Learning (ML) model with a second index. The method may further include performing the first AI/ML model or the second AI/ML model based on the first index and the second index in a case that the first AI/ML model overlaps with the second AI/ML model on a predefined AI/ML model unit(s).

The 3rd Generation Partnership Project, also referred to as “3GPP,” is a collaboration agreement that aims to define globally applicable technical specifications and technical reports for third and fourth generation wireless communication systems. The 3GPP may define specifications for next generation mobile networks, systems and devices.

3GPP Long Term Evolution (LTE) is the name given to a project to improve the Universal Mobile Telecommunications System (UMTS) mobile phone or device standard to cope with future requirements. In one aspect, UMTS has been modified to provide support and specification for the Evolved Universal Terrestrial Radio Access (E-UTRA) and Evolved Universal Terrestrial Radio Access Network (E-UTRAN).

At least some aspects of the systems and methods disclosed herein may be described in relation to the 3GPP LTE, LTE-Advanced (LTE-A), LTE-Advanced Pro and other standards (e.g., 3GPP Releases 8, 9, 10, 11, 12, 13, 14, 15, 16, 17, and/or 18). However, the scope of the present disclosure should not be limited in this regard. At least some aspects of the systems and methods disclosed herein may be utilized in other types of wireless communication systems.

A wireless communication device may be an electronic device used to communicate voice and/or data to a base station, which in turn may communicate with a network of devices (e.g., public switched telephone network (PSTN), the Internet, etc.). In describing systems and methods herein, a wireless communication device may alternatively be referred to as a mobile station, a UE, an access terminal, a subscriber station, a mobile terminal, a remote station, a user terminal, a terminal, a subscriber unit, a mobile device, etc. Examples of wireless communication devices include cellular phones, smart phones, personal digital assistants (PDAs), laptop computers, netbooks, e-readers, wireless modems, etc. In 3GPP specifications, a wireless communication device is typically referred to as a UE. However, as the scope of the present disclosure should not be limited to the 3GPP standards, the terms “UE” and “wireless communication device” may be used interchangeably herein to mean the more general term “wireless communication device.” A UE may also be more generally referred to as a terminal device.

In 3GPP specifications, a base station is typically referred to as a Node B, an evolved Node B (eNB), a home enhanced or evolved Node B (HeNB), a g Node B (gNB) or some other similar terminology. As the scope of the disclosure should not be limited to 3GPP standards, the terms “base station,” “Node B,” “eNB,” “gNB” and “HeNB” may be used interchangeably herein to mean the more general term “base station.” Furthermore, the term “base station” may be used to denote an access point. An access point may be an electronic device that provides access to a network (e.g., Local Area Network (LAN), the Internet, etc.) for wireless communication devices. The term “communication device” may be used to denote both a wireless communication device and/or a base station. An gNB may also be more generally referred to as a base station device.

It should be noted that as used herein, a “cell” may be any communication channel that is specified by standardization or regulatory bodies to be used for International Mobile Telecommunications-Advanced (IMT-Advanced) or IMT-2020, and all of it or a subset of it may be adopted by 3GPP as licensed bands or unlicensed bands (e.g., frequency bands) to be used for communication between an eNB or gNB and a UE. It should also be noted that in E-UTRA and E-UTRAN overall description, as used herein, a “cell” may be defined as “combination of downlink and optionally uplink resources.” The linking between the carrier frequency of the downlink resources and the carrier frequency of the uplink resources may be indicated in the system information transmitted on the downlink resources.

The 5th generation communication systems, dubbed NR (New Radio technologies) by 3GPP, envision the use of time/frequency/space resources to allow for services, such as eMBB (enhanced Mobile Broad-Band) transmission, URLLC (Ultra Reliable and Low Latency Communication) transmission, and mMTC (massive Machine Type Communication) transmission. And, in NR, transmissions for different services may be specified (e.g., configured) for one or more bandwidth parts (BWPs) in a serving cell and/or for one or more serving cells. A user equipment (UE) may receive a downlink signal(s) and/or transmit an uplink signal(s) in the BWP(s) of the serving cell and/or the serving cell(s).

In order for the services to use the time, frequency, and/or spatial resources efficiently, it would be useful to be able to efficiently control downlink and/or uplink transmissions. Therefore, a procedure for efficient control of downlink and/or uplink transmissions should be designed. Accordingly, a detailed design of a procedure for downlink and/or uplink transmissions may be beneficial.

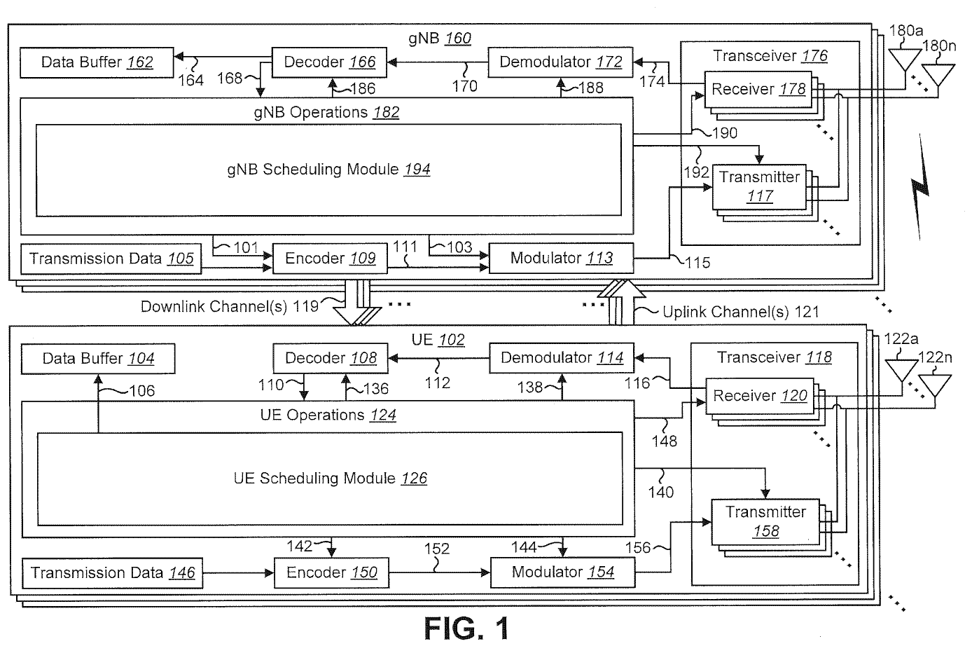

FIG. 1 is a block diagram illustrating one implementation of one or more gNBs 160 and one or more UEs 102 in which systems and methods for signaling may be implemented. The one or more UEs 102 communicate with one or more gNBs 160 using one or more physical antennas 122a-n. For example, a UE 102 transmits electromagnetic signals to the gNB 160 and receives electromagnetic signals from the gNB 160 using the one or more physical antennas 122a-n. The gNB 160 communicates with the UE 102 using one or more physical antennas 180a-n. In some implementations, the term “base station,” “eNB,” and/or “gNB” may refer to and/or may be replaced by the term “Transmission Reception Point (TRP).” For example, the gNB 160 described in connection with FIG. 1 may be a TRP in some implementations.

The UE 102 and the gNB 160 may use one or more channels and/or one or more signals 119, 121 to communicate with each other. For example, the UE 102 may transmit information or data to the gNB 160 using one or more uplink channels 121. Examples of uplink channels 121 include a physical shared channel (e.g., PUSCH (physical uplink shared channel)) and/or a physical control channel (e.g., PUCCH (physical uplink control channel)), etc. The one or more gNBs 160 may also transmit information or data to the one or more UEs 102 using one or more downlink channels 119, for instance. Examples of downlink channels 119 include a physical shared channel (e.g., PDSCH (physical downlink shared channel) and/or a physical control channel (PDCCH (physical downlink control channel)), etc. Other kinds of channels and/or signals may be used.

Each of the one or more UEs 102 may include one or more transceivers 118, one or more demodulators 114, one or more decoders 108, one or more encoders 150, one or more modulators 154, a data buffer 104 and a UE operations module 124. For example, one or more reception and/or transmission paths may be implemented in the UE 102. For convenience, only a single transceiver 118, decoder 108, demodulator 114, encoder 150 and modulator 154 are illustrated in the UE 102, though multiple parallel elements (e.g., transceivers 118, decoders 108, demodulators 114, encoders 150 and modulators 154) may be implemented.

The transceiver 118 may include one or more receivers 120 and one or more transmitters 158. The one or more receivers 120 may receive signals from the gNB 160 using one or more antennas 122a-n. For example, the receiver 120 may receive and downconvert signals to produce one or more received signals 116. The one or more received signals 116 may be provided to a demodulator 114. The one or more transmitters 158 may transmit signals to the gNB 160 using one or more physical antennas 122a-n. For example, the one or more transmitters 158 may upconvert and transmit one or more modulated signals 156.

The demodulator 114 may demodulate the one or more received signals 116 to produce one or more demodulated signals 112. The one or more demodulated signals 112 may be provided to the decoder 108. The UE 102 may use the decoder 108 to decode signals. The decoder 108 may produce decoded signals 110, which may include a UE-decoded signal 106 (also referred to as a first UE-decoded signal 106). For example, the first UE-decoded signal 106 may comprise received payload data, which may be stored in a data buffer 104. Another signal included in the decoded signals 110 (also referred to as a second UE-decoded signal 110) may comprise overhead data and/or control data. For example, the second UE decoded signal 110 may provide data that may be used by the UE operations module 124 to perform one or more operations.

In general, the UE operations module 124 may enable the UE 102 to communicate with the one or more gNBs 160. The UE operations module 124 may include one or more of a UE scheduling module 126.

The UE scheduling module 126 may perform downlink reception(s) and uplink transmission(s). The downlink reception(s) include reception of data, reception of downlink control information, and/or reception of downlink reference signals. Also, the uplink transmissions include transmission of data, transmission of uplink control information, and/or transmission of uplink reference signals.

Also, in a carrier aggregation (CA), the gNB 160 and the UE 102 may communicate with each other using a set of serving cells. Here a set of serving cells may include one primary cell and one or more secondary cells. For example, the gNB 160 may transmit, by using the RRC message, information used for configuring one or more secondary cells to form together with the primary cell a set of serving cells. Namely, the set of serving cells may include one primary cell and one or more secondary cells. Here, the primary cell may be always activated. Also, the gNB 160 may activate zero or more secondary cell within the configured secondary cells. Here, in the downlink, a carrier corresponding to the primary cell may be the downlink primary component carrier (i.e., the DL PCC), and a carrier corresponding to a secondary cell may be the downlink secondary component carrier (i.e., the DL SCC). Also, in the uplink, a carrier corresponding to the primary cell may be the uplink primary component carrier (i.e., the UL PCC), and a carrier corresponding to the secondary cell may be the uplink secondary component carrier (i.e., the UL SCC).

Also, in a single cell operation, the gNB 160 and the UE 102 may communicate with each other using one serving cell. Here, the serving cell may be a primary cell.

In a radio communication system, physical channels (uplink physical channels and/or downlink physical channels) may be defined. The physical channels (uplink physical channels and/or downlink physical channels) may be used for transmitting information that is delivered from a higher layer and/or information that is generated from a physical layer.

### PRACH

For example, in uplink, a PRACH (Physical Random Access Channel) may be defined. In some approaches, the PRACH (e.g., as part of a random access procedure) may be used for an initial access connection establishment procedure, a handover procedure, a connection re-establishment, a timing adjustment (e.g., a synchronization for an uplink transmission, for UL synchronization) and/or for requesting an uplink shared channel (UL-SCH) resource (e.g., the uplink physical shared channel (PSCH) (e.g., PUSCH) resource).

### PUCCH

In another example, a physical uplink control channel (PUCCH) may be defined. The PUCCH may be used for transmitting uplink control information (UCI). The UCI may include hybrid automatic repeat request-acknowledgement (HARQ-ACK), channel state information (CSI) and/or a scheduling request (SR). The HARQ-ACK is used for indicating a positive acknowledgement (ACK) or a negative acknowledgment (NACK) for downlink data (e.g., Transport block(s), Medium Access Control Protocol Data Unit (MAC PDU) and/or Downlink Shared Channel (DL-SCH)). The CSI is used for indicating state of downlink channel (e.g., a downlink signal(s)). Also, the SR is used for requesting resources of uplink data (e.g., Transport block(s), MAC PDU and/or Uplink Shared Channel (UL-SCH)).

Here, the DL-SCH and/or the UL-SCH may be a transport channel that is used in the MAC layer. Also, a transport block(s) (TB(s)) and/or a MAC PDU may be defined as a unit(s) of the transport channel used in the MAC layer. The transport block may be defined as a unit of data delivered from the MAC layer to the physical layer. The MAC layer may deliver the transport block to the physical layer (e.g., the MAC layer delivers the data as the transport block to the physical layer). In the physical layer, the transport block may be mapped to one or more codewords.

### PDCCH

In downlink, a physical downlink control channel (PDCCH) may be defined. The PDCCH may be used for transmitting downlink control information (DCI). Here, more than one DCI formats may be defined for DCI transmission on the PDCCH. Namely, fields may be defined in the DCI format(s), and the fields are mapped to the information bits (e.g., DCI bits).

### PDSCH and PUSCH

A physical downlink shared channel (PDSCH) and a physical uplink shared channel (PUSCH) may be defined. For example, in a case that the PDSCH (e.g., the PDSCH resource) is scheduled by using the DCI format(s) for the downlink, the UE 102 may receive the downlink data, on the scheduled PDSCH (e.g., the PDSCH resource). Alternatively, in a case that the PUSCH (e.g., the PUSCH resource) is scheduled by using the DCI format(s) for the uplink, the UE 102 transmits the uplink data, on the scheduled PUSCH (e.g., the PUSCH resource). For example, the PDSCH may be used to transmit the downlink data (e.g., DL-SCH(s), a downlink transport block(s)). Additionally or alternatively, the PUSCH may be used to transmit the uplink data (e.g., ULSCH(s), an uplink transport block(s)).

Furthermore, the PDSCH and/or the PUSCH may be used to transmit information of a higher layer (e.g., a radio resource control (RRC)) layer, and/or a MAC layer). For example, the PDSCH (e.g., from the gNB 160 to the UE 102) and/or the PUSCH (e.g., from the UE 102 to the gNB 160) may be used to transmit a RRC message (a RRC signal). Additionally or alternatively, the PDSCH (e.g., from the gNB 160 to the UE 102) and/or the PUSCH (e.g., from the UE 102 to the gNB 160) may be used to transmit a MAC control element (a MAC CE). Here, the RRC message and/or the MAC CE are also referred to as a higher layer signal.

### SS/PBCH Block

In some approaches, a physical broadcast channel (PBCH) may be defined. For example, the PBCH may be used for broadcasting the MIB (master information block). Here, system information may be divided into the MIB and a number of SIB(s) (system information block(s)). For example, the MIB may be used for carrying minimum system information. Additionally or alternatively, the SIB(s) may be used for carrying system information messages.

In some approaches, in downlink, synchronization signals (SSs) may be defined. The SS may be used for acquiring time and/or frequency synchronization with a cell. Additionally or alternatively, the SS may be used for detecting a physical layer cell ID of the cell. SSs may include a primary SS and a secondary SS.

An SS/PBCH block may be defined as a set of a primary SS, a secondary SS and a PBCH. In the time domain, the SS/PBCH block consists of 4 OFDM symbols, numbered in terms of OFDM symbols in increasing order from 0 to 3 within the SS/PBCH block, where PSS, SSS, and PBCH with associated demodulation reference signal (DMRS) are mapped to symbols. One or more SS/PBCH blocks may be mapped within a certain time duration (e.g. 5 msec).

Additionally, the SS/PBCH block may be used for beam measurement, radio resource management (RRM) measurement and radio link monitoring (RLM) measurement. Specifically, the secondary synchronization signal (SSS) may be used for the measurement.

In the radio communication for uplink, UL RS(s) may be used as uplink physical signal(s). Additionally or alternatively, in the radio communication for downlink, DL RS(s) may be used as downlink physical signal(s). The uplink physical signal(s) and/or the downlink physical signal(s) may not be used to transmit information that is provided from the higher layer where the information is used by a physical layer.

Here, the downlink physical channel(s) and/or the downlink physical signal(s) described herein may be assumed to be included in a downlink signal (e.g., a DL signal(s)) in some implementations for the sake of simple descriptions. Additionally or alternatively, the uplink physical channel(s) and/or the uplink physical signal(s) described herein may be assumed to be included in an uplink signal (i.e. an UL signal(s)) in some implementations for the sake of simple descriptions.

### Numerology and Slot Configuration

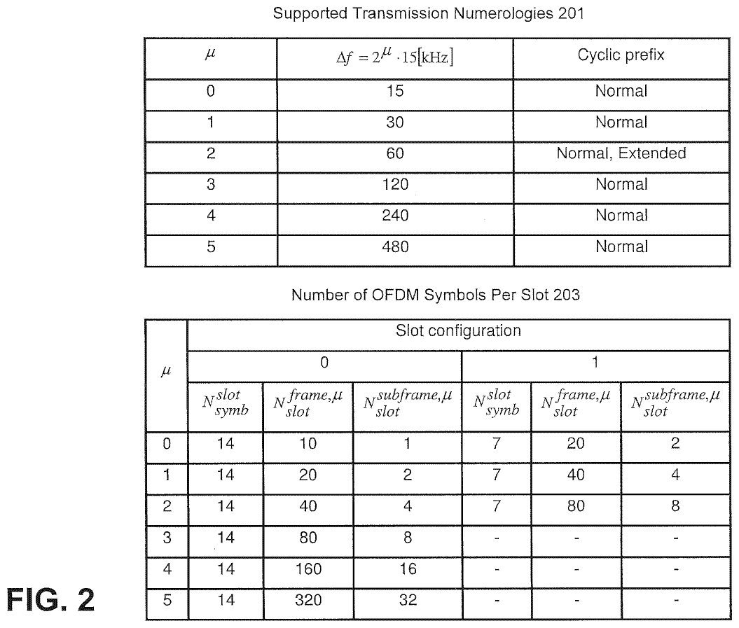

FIG. 2 shows examples of multiple numerologies 201. As shown in FIG. 2, multiple numerologies 201 (e.g., multiple subcarrier spacing) may be supported. For example, u (e.g., a subcarrier space configuration) and a cyclic prefix (e.g., the u and the cyclic prefix for a BWP) may be configured by higher layer parameters (e.g., a RRC message) for the downlink and/or the uplink. Here, 15 kHz may be a reference numerology 201. For example, an RE of the reference numerology 201 may be defined with a subcarrier spacing of 15 kHz in a frequency domain and 2048 Ts+CP length (e.g., 160 Ts or 144 Ts) in a time domain, where Ts denotes a baseband sampling time unit defined as 1/(15000*2048) seconds.
Further, time unit T_{c} may be used for expression of the length of the time domain. For the time unit T_{c}, T_{c}=1/(Δfₘₐₓ·N_{f}) where Δfₘₐₓ=480 kHz and N_{f}=4096. For a constant κ, κ=Δfₘₐₓ·N_{f}/(Δf_{ref}N_{f,ref})=64·Δf_{ref} is 15 kHz. N_{f,ref} is 2048.
Transmission of a signal in the downlink and/or transmission of a signal in the uplink may be organized into a radio frame having the length T_{f}, T_{f}==(ΔfₘₐₓN_{f}/100)·Tₛ=10 ms. Here, “·” represents multiplication. The radio frame includes 10 subframes. For the length T_{sf} of the subframe, T_{sf}=(ΔfₘₐₓN_{f}/1000). Tₛ=1 ms. For the number of OFDM symbols per subframe, N^{subframe,μ}_{symb}=N^{slot}_{symb}N^{subframe,μ}ₛₗₒₜ.

### Additionally or Alternatively, a Number of OFDM Symbol(s) 203 Per Slot

$$( {N}_{symb}^{slot} )$$

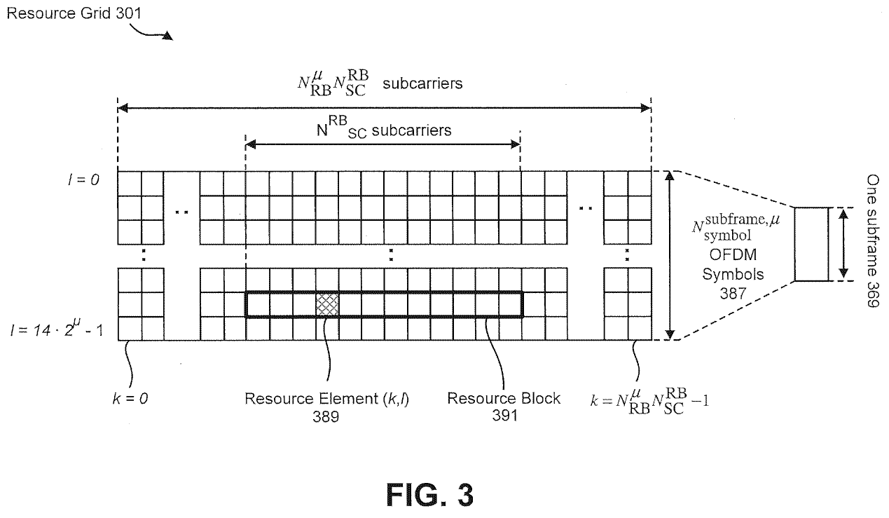

may be determined based on the u (e.g., the subcarrier space configuration). FIG. 3 is a diagram illustrating one example of a resource grid 301 and resource block 391 (e.g., for the downlink and/or the uplink). The resource grid 301 and resource block 391 illustrated in FIG. 3 may be utilized in some implementations of the systems and methods disclosed herein. In another example, the resource block 391 may include N^{RB}_{sc} continuous subcarriers. In another example, the resource block 391 may consists of N^{RB}_{sc} continuous subcarriers.

### In FIG. 3, One Subframe 369 May Include

$${N}_{symbol}^{subframe , μ}$$

symbols 387. Additionally or alternatively, a resource block 391 may include a number of resource elements (RE) 389. Here, in the downlink, the OFDM access scheme with cyclic prefix (CP) may be employed, which may be also referred to as CP-OFDM. A downlink radio frame may include multiple pairs of downlink resource blocks (RBs) 391 which is also referred to as physical resource blocks (PRBs). The downlink RB pair is a unit for assigning downlink radio resources, defined by a predetermined bandwidth (RB bandwidth) and a time slot. The downlink RB pair may include two downlink RBs 391 that are continuous in the time domain. Additionally or alternatively, the downlink RB 391 may include twelve sub-carriers in frequency domain and seven (for normal CP) or six (for extended CP) OFDM symbols in time domain. A region defined by one sub-carrier in frequency domain and one OFDM symbol in time domain is referred to as a resource element (RE) 389 and is uniquely identified by the index pair (k,l), where k and l are indices in the frequency and time domains, respectively.

Additionally or alternatively, in the uplink, in addition to CP-OFDM, a Single-Carrier Frequency Division Multiple Access (SC-FDMA) access scheme may be employed, which is also referred to as Discrete Fourier Transform-Spreading OFDM (DFT-S-OFDM). An uplink radio frame may include multiple pairs of uplink resource blocks 391. The uplink RB pair is a unit for assigning uplink radio resources, defined by a predetermined bandwidth (RB bandwidth) and a time slot. The uplink RB pair may include two uplink RBs 391 that are continuous in the time domain. The uplink RB may include twelve sub-carriers in frequency domain and seven (for normal CP) or six (for extended CP) OFDM/DFT-S-OFDM symbols in time domain. A region defined by one sub-carrier in the frequency domain and one OFDM/DFT-S-OFDM symbol in the time domain is referred to as a resource element (RE) 389 and is uniquely identified by the index pair (k,l) in a slot, where k and l are indices in the frequency and time domains respectively.

Each element in the resource grid 301 on antenna port p and the subcarrier configuration μ is called a resource element 389 and is uniquely identified by the index pair (k,l) where k=0, . . . ,

$${N}_{RB}^{μ} {N}_{SC}^{RB} - 1$$

is the index in the frequency domain and l refers to the symbol position in the time domain. The resource element (k,l) 389 on the antenna port p and the subcarrier spacing configuration u is denoted (k,l)ₚ, μ. The physical resource block 391 is defined as

$${N}_{SC}^{RB} = 12$$

consecutive subcarriers in the frequency domain. The physical resource blocks 391 are numbered from 0 to

$${N}_{RB}^{μ} - 1$$

in the frequency domain. The relation between the physical resource block number

$${n}_{PRB}$$

in the frequency domain and the resource element (k,l) is given by

$${n}_{PRB} = ⌊ \frac{k}{{N}_{SC}^{RB}} ⌋$$

### Reference Signal

In the NR, the following reference signals may be defined
NZP CSI-RS (non-zero power channel state information reference signal)
ZP CSI-RS (Zero-power channel state information reference signal)
DMRS (demodulation reference signal)
SRS (sounding reference signal)
NZP CSI-RS may be used for channel tracking (e.g. synchronization), measurement to obtain CSI (CSI measurement including channel measurement and interference measurement), measurement to obtain the beam forming performance. NZP CSI-RS may be transmitted in the downlink (gNB to UE). NZP CSI-RS may be transmitted in an aperiodic or semi-persistent or periodic manner. Additionally, the NZP CSI-RS can be used for radio resource management (RRM) measurement and radio link control (RLM) measurement.
ZP CSI-RS may be used for interference measurement and transmitted in the downlink (gNB to UE). ZP CSI-RS may be transmitted in an aperiodic or semipersistent or periodic manner.
DMRS may be used for demodulation for the downlink (gNB to UE), the uplink (UE to gNB), and the sidelink (UE to UE).
SRS may be used for channel sounding and beam management. The SRS may be transmitted in the uplink (UE to gNB).

### DCI Format

In Some Approaches, the DCI May be Used. The Following DCI Formats May be Defined
DCI format 0_0
DCI format 0_1
DCI format 0_2
DCI format 1_0
DCI format 1_1
DCI format 1_2
DCI format 2_0
DCI format 2_1
DCI format 2_2
DCI format 2_3
DCI format 2_4
DCI format 2_5
DCI format 2_6
DCI format 3_0
DCI format 3_1
DCI format 0_0 may be used for the scheduling of PUSCH in one cell. The DCI may be transmitted by means of the DCI format 0_0 with cyclic redundancy check (CRC) scrambled by Cell Radio Network Temporary Identifiers (C-RNTI) or Configured Scheduling RNTI (CS-RNTI) or Modulation and Coding Scheme-Cell RNTI (MCS-C-RNTI) or temporally cell RNTI (TC-RNTI).

DCI format 0_1 may be used for the scheduling of one or multiple PUSCH in one cell, or indicating configured grant downlink feedback information (CG-DFI) to a UE. The DCI may be transmitted by means of the DCI format 0_1 with CRC scrambled by C-RNTI or CS-RNTI or semi-persistent channel state information (SP-CSI-RNTI) or MCS-C-RNTI. The DCI format 0_2 may be used for CSI request (e.g. aperiodic CSI reporting or semi-persistent CSI request). The DCI format 0_2 may be used for SRS request (e.g. aperiodic SRS transmission).

DCI format 0_2 may be used for the scheduling of PUSCH in one cell. The DCI may be transmitted by means of the DCI format 0_2 with CRC scrambled by C-RNTI or CS-RNTI or SP-CSI-RNTI or MCS-C-RNTI. The DCI format 0_2 may be used for scheduling of PUSCH with high priority and/or low latency (e.g. URLLC). The DCI format 0_2 may be used for CSI request (e.g. aperiodic CSI reporting or semipersistent CSI request). The DCI format 0_2 may be used for SRS request (e.g. aperiodic SRS transmission).

Additionally, for example, the DCI included in the DCI format 0_Y (Y=0, 1, 2, . . . ) may be a BWP indicator (e.g., for the PUSCH). Additionally or alternatively, the DCI included in the DCI format 0_Y may be a frequency domain resource assignment (e.g., for the PUSCH). Additionally or alternatively, the DCI included in the DCI format 0_Y may be a time domain resource assignment (e.g., for the PUSCH). Additionally or alternatively, the DCI included in the DCI format 0_Y may be a modulation and coding scheme (e.g., for the PUSCH). Additionally or alternatively, the DCI included in the DCI format 0_Y may be a new data indicator. Additionally or alternatively, the DCI included in the DCI format 0_Y may be a TPC command for scheduled PUSCH. Additionally or alternatively, the DCI included in the DCI format 0_Y may be a CSI request that is used for requesting the CSI reporting. Additionally or alternatively, as described below, the DCI included in the DCI format 0_Y may be information used for indicating an index of a configuration of a configured grant. Additionally or alternatively, the DCI included in the DCI format 0_Y may be the priority indication (e.g., for the PUSCH transmission and/or for the PUSCH reception).

DCI format 1_0 may be used for the scheduling of PDSCH in one DL cell. The DCI is transmitted by means of the DCI format 1_0 with CRC scrambled by C-RNTI or CS-RNTI or MCS-C-RNTI. The DCI format 1_0 may be used for random access procedure initiated by a PDCCH order. Additionally or alternately, the DCI may be transmitted by means of the DCI format 1_0 with CRC scrambled by system information RNTI (SI-RNTI), and the DCI may be used for system information transmission and/or reception. Additionally or alternately, the DCI may be transmitted by means of the DCI format 1_0 with CRC scrambled by random access RNTI (RA-RNTI) for random access response (RAR) (e.g. Msg 2) or msgB-RNTI for 2-step RACH. Additionally or alternately, the DCI may be transmitted by means of the DCI format 1_0 with CRC scrambled by temporally cell RNTI (TC-RNTI), and the DCI may be used for msg3 transmission by a UE 102.

DCI format 1_1 may be used for the scheduling of PDSCH in one cell. The DCI may be transmitted by means of the DCI format 1_1 with CRC scrambled by C-RNTI or CS-RNTI or MCS-C-RNTI. The DCI format 1_1 may be used for SRS request (e.g. aperiodic SRS transmission).

DCI format 1_2 may be used for the scheduling of PDSCH in one cell. The DCI may be transmitted by means of the DCI format 1_2 with CRC scrambled by C-RNTI or CS-RNTI or SP-CSI-RNTI or MCS-C-RNTI. The DCI format 1_2 may be used for scheduling of PDSCH with high priority and/or low latency (e.g. URLLC). The DCI format 1_2 may be used for SRS request (e.g. aperiodic SRS transmission).

Additionally, for example, the DCI included in the DCI format 1_X may be a BWP indicator (e.g., for the PDSCH). Additionally or alternatively, the DCI included in the DCI format 1_X may be frequency domain resource assignment (e.g., for the PDSCH). Additionally or alternatively, the DCI included in the DCI format 1_X may be a time domain resource assignment (e.g., for the PDSCH). Additionally or alternatively, the DCI included in the DCI format 1_X may be a modulation and coding scheme (e.g., for the PDSCH). Additionally or alternatively, the DCI included in the DCI format 1_X may be a new data indicator. Additionally or alternatively, the DCI included in the DCI format 1_X may be a TPC command for scheduled PUCCH. Additionally or alternatively, the DCI included in the DCI format 1_X may be a CSI request that is used for requesting (e.g., triggering) transmission of the CSI (e.g., CSI reporting (e.g., aperiodic CSI reporting)). Additionally or alternatively, the DCI included in the DCI format 1_X may be a PUCCH resource indicator. Additionally or alternatively, the DCI included in the DCI format 1_X may be a PDSCH-to-HARQ feedback timing indicator. Additionally or alternatively, the DCI included in the DCI format 1_X may be the priority indication (e.g., for the PDSCH transmission and/or the PDSCH reception). Additionally or alternatively, the DCI included in the DCI format 1_X may be the priority indication (e.g., for the HARQ-ACK transmission for the PDSCH and/or the HARQ-ACK reception for the PDSCH).

DCI format 2_0 may be used for notifying the slot format, channel occupancy time (COT) duration for unlicensed band operation, available resource block (RB) set, and search space group switching. The DCI may transmitted by means of the DCI format 2_0 with CRC scrambled by slot format indicator RNTI (SFI-RNTI).

DCI format 2_1 may be used for notifying the physical resource block(s) (PRB(s)) and orthogonal frequency division multiplexing (OFDM) symbol(s) where UE may assume no transmission is intended for the UE. The DCI is transmitted by means of the DCI format 2_1 with CRC scrambled by interrupted transmission RNTI (INT-RNTI).

DCI format 2_2 may be used for the transmission of transmission power control (TPC) commands for PUCCH and PUSCH. The following information is transmitted by means of the DCI format 2_2 with CRC scrambled by TPC-PUSCH-RNTI or TPC-PUCCH-RNTI. In a case that the CRC is scrambled by TPC-PUSCH-RNTI, the indicated one or more TPC commands may applied to the TPC loop for PUSCHs. In a case that the CRC is scrambled by TPC-PUCCH-RNTI, the indicated one or more TPC commands may be applied to the TPC loop for PUCCHs.

DCI format 2_3 may be used for the transmission of a group of TPC commands for SRS transmissions by one or more UEs. Along with a TPC command, a SRS request may also be transmitted. The DCI may be is transmitted by means of the DCI format 2_3 with CRC scrambled by TPC-SRS-RNTI.

DCI format 2_4 may be used for notifying the PRB(s) and OFDM symbol(s) where UE cancels the corresponding UL transmission. The DCI may be transmitted by means of the DCI format 2_4 with CRC scrambled by cancellation indication RNTI (CI-RNTI).

DCI format 2_5 may be used for notifying the availability of soft resources for integrated access and backhaul (IAB) operation. The DCI may be transmitted by means of the DCI format 2_5 with CRC scrambled by availability indication RNTI (AI-RNTI).

DCI format 2_6 may be used for notifying the power saving information outside discontinuous reception (DRX) Active Time for one or more UEs. The DCI may transmitted by means of the DCI format 2_6 with CRC scrambled by power saving RNTI (PS-RNTI).

DCI format 3_0 may be used for scheduling of NR physical sidelink control channel (PSCCH) and NR physical sidelink shared channel (PSSCH) in one cell. The DCI may be transmitted by means of the DCI format 3_0 with CRC scrambled by sidelink RNTI (SL-RNTI) or sidelink configured scheduling RNTI (SL-CS-RNTI). This may be used for vehicular to everything (V2X) operation for NR V2X UE(s).

DCI format 3_1 may be used for scheduling of LTE PSCCH and LTE PSSCH in one cell. The following information is transmitted by means of the DCI format 3_1 with CRC scrambled by SL-L-CS-RNTI. This may be used for LTE V2X operation for LTE V2X UE(s).

### Search Space

The UE 102 may monitor one or more DCI formats on common search space set (CSS) and/or UE-specific search space set (USS). A set of PDCCH candidates for a UE to monitor may be defined in terms of PDCCH search space sets. A search space set can be a CSS set or a USS set. A UE 102 monitors PDCCH candidates in one or more of the following search spaces sets. The search space may be defined by a PDCCH configuration in a RRC layer.
a Type0-PDCCH CSS set configured by pdcch-ConfigSIB1 in MIB or by searchSpaceSIB1 in PDCCH-ConfigCommon or by searchSpaceZero in PDCCHConfigCommon for a DCI format with CRC scrambled by a SI-RNTI on the primary cell of the MCG
a Type0A-PDCCH CSS set configured by searchSpaceOtherSystemInformation in PDCCH-ConfigCommon for a DCI format with CRC scrambled by a SI-RNTI on the primary cell of the MCG
a Type1-PDCCH CSS set configured by ra-SearchSpace in PDCCHConfigCommon for a DCI format with CRC scrambled by a RA-RNTI or a TC-RNTI on the primary cell
a Type2-PDCCH CSS set configured by pagingSearchSpace in PDCCHConfigCommon for a DCI format with CRC scrambled by a P-RNTI on the primary cell of the MCG
a Type3-PDCCH CSS set configured by SearchSpace in PDCCH-Config with searchSpaceType=common for DCI formats with CRC scrambled by INT-RNTI, SFI-RNTI, TPC-PUSCH-RNTI, TPC-PUCCH-RNTI, TPC-SRS-RNTI, CI-RNTI, or PS-RNTI and, only for the primary cell, C-RNTI, MCS-C-RNTI, or CS-RNTI(s), and
a USS set configured by SearchSpace in PDCCH-Config with searchSpaceType=ue-Specific for DCI formats with CRC scrambled by C-RNTI, MCS-C-RNTI, SP-CSI-RNTI, CS-RNTI(s), SL-RNTI, SL-CS-RNTI, or SL-L-CS-RNTI.

The UE 102 may monitor a set of candidates of the PDCCH in one or more control resource sets (e.g., CORESETs) on the active DL bandwidth part (BWP) on each activated serving cell according to corresponding search space sets. The CORESETs may be configured from gNB 160 to a UE 102, and the CSS set(s) and the USS set(s) are defined in the configured CORESET. One or more CORESET may be configured in a RRC layer.

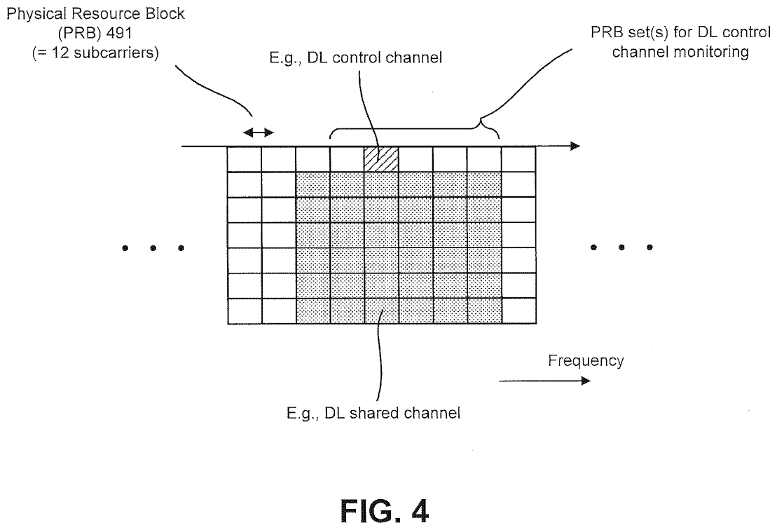

FIG. 4 shows examples of resource regions (e.g., resource region of the downlink). One or more sets 401 of PRB(s) 491 (e.g., a control resource set (e.g., CORESET)) may be configured for DL control channel monitoring (e.g., the PDCCH monitoring). For example, the CORESET is, in the frequency domain and/or the time domain, a set 401 of PRBs 491 within which the UE 102 attempts to decode the DCI (e.g., the DCI format(s), the PDCCH(s)), where the PRBs 491 may or may not be frequency contiguous and/or time contiguous, a UE 102 may be configured with one or more control resource sets (e.g., the CORESETs) and one DCI message may be mapped within one control resource set. In the frequency-domain, a PRB 491 is the resource unit size (which may or may not include DM-RS) for the DL control channel.

### Beamforming and QCL Type

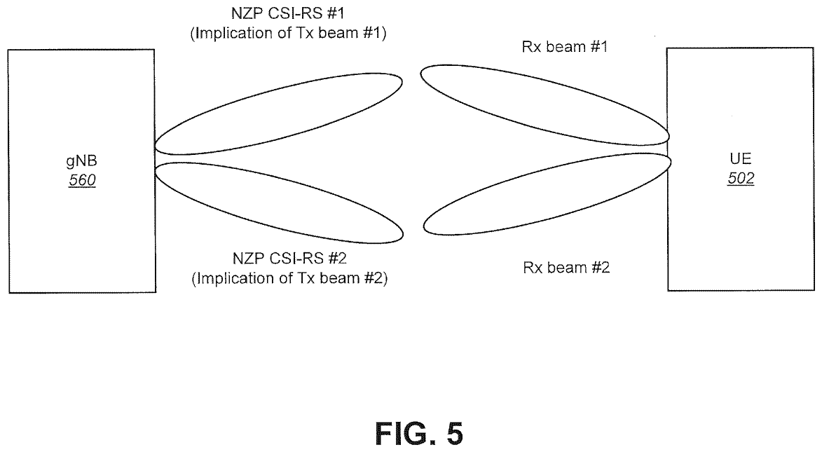

In FIG. 5, the gNB 560 and UE 502 may perform beamforming by having multiple antenna elements. The beamforming is operated by using a directional antenna(s) or applying phase shift for each antenna element and the high electric field strength to a certain spatial direction can be achieved. Here, The beamforming or beam may be rephrased by “spatial domain transmission filter” or “spatial domain filter”.

In the downlink, gNB 560 may apply the transmission beamforming and transmit the DL channels and/or DL signals and a UE 502 may also apply the reception beamforming and receive the DL channels and/or DL signals.

In the uplink, a UE 502 may apply the transmission beamforming and transmit the UL channels and/or UL signals and a gNB 560 may also apply the reception beamforming and receive the UL channels and/or UL signals.

The beam correspondence may be defined according to the UE capability. The beam correspondence may be defined as the followings:
In the downlink, a UE 502 can decide the transmission beamforming for UL channels and/or UL signals from the reception beamforming for DL channels and/or DL signals
In the uplink, a gNB 560 can decide the transmission beamforming for DL channels and/or DL signals from the reception beamforming for UL channels and/or UL signals

To adaptively switch, refine, or operate beamforming, beam management may be performed. For the beam management, NZP-CSI-RS(s) and SRS(s) may be used to measure the channel quality in the downlink and uplink respectively. Specifically, in the downlink, gNB 560 may transmit one or more NZP CSI-RSs. The UE 502 measure the one or more NZP CSI-RSs. In addition, the UE 502 may change the beamforming to receive each NZP CSI-RS. The UE 102 can identify which combination of transmission beamforming at gNB side corresponding to NZP CSI-RS corresponding and the reception beamforming at the UE side. In the uplink, a UE 502 may transmit one or more SRSs. The gNB 560 measure the one or more SRSs. In addition, the gNB 560 may change the reception beamforming to receive each SRS. The gNB 560 can identify which combination of transmission beamforming at gNB side corresponding to SRS corresponding and the reception beamforming at the gNB side.

To keep the link with transmission beam and reception for the communication between a gNB and a UE, the quasi-colocation (QCL) assumption may be defined. Two antenna ports are said to be quasi co-located if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters. The following QCL types may be defined:
QCL type A (‘QCL-TypeA’): {Doppler shift, Doppler spread, average delay, delay spread}
QCL type B (‘QCL-TypeB’): {Doppler shift, Doppler spread}
QCL type C (‘QCL-TypeC’): {Doppler shift, average delay}
QCL type D (‘QCL-TypeD’) {Spatial Rx parameter}

QCL type D is related to the beam management. For example, two NZP CSI-RS resources are configured to a UE 502 and a NZP CSI-RS resource #1 and a NZP CSIRS resource #2 are used for beam #1 and beam #2, respectively. At a UE side, Rx beam #1 is used for the reception of the NZP CSI-RS #1 and Rx beam #2 is used for reception of the NZP CSI-RS #2 for beam management. Here, the NZP CSI-RS resource #1 and NZP CSI-RS resource #2 imply Tx beam #1 and Tx beam #2 respectively. QCL type D assumption may be used for PDCCH and PDSCH and DL signals reception. When a UE 502 receives a PDCCH with the QCL type D assumption of NZP CSI-RS #1, the UE may use the Rx beam #2 for the PDCCH reception.

For this purpose, a gNB may configure transmission configuration indication (TCI) states to a UE 102. A TCI state includes.
One or more reference resource indices
QCL type for each of the one or more reference resource indices

For example, if a TCI state includes QCL type D and NZP CSI-RS #1 and indicated to the UE 502. The UE 502 may apply Rx beam #1 to the reception of a PDCCH, a PDSCH, and/or DL signal(s). In other words, a UE 102 can determine the reception beam by using TCI states for reception of PDCCH, PDSCH, and/or DL signals.

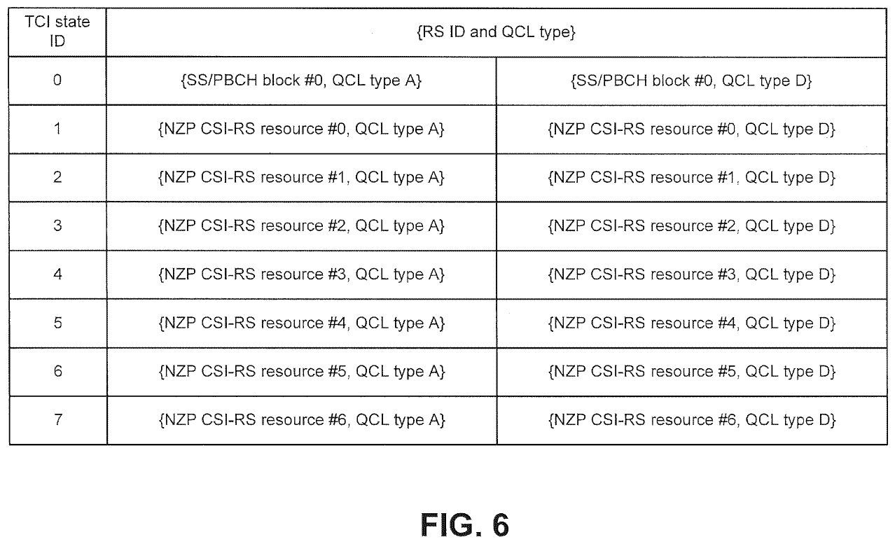

FIG. 6 illustrates an example of TCI states. The seven TCI states are configured and one of the configured TCI states are used to receive PDCCH, PDSCH, and/or DL signals. For example, if gNB 160 indicates TCI state #1, a UE 102 may assume the PDCCH, PDSCH, and/or DL signals is (are) quasi-colocated with the NZP CSI-RS corresponding to the NZP CSI-RS resource #1. A UE 102 may determine to use the reception beam when the UE 102 receives the NZP CSI-RS corresponding to the NZP CSI-RS resource #1.

Next, how to indicate one TCI state to a UE 102 from gNB 160. In the RRC messages, N TCI states may be configured by a RRC message. A gNB 160 may indicate one of the configured TCI states by DCI e.g. DCI format 1_1 or DCI format 1_2. Alternately or additionally, the gNB 160 may indicate one of the configured TCI by MAC CE. Alternately or additionally, the MAC CE selects more than one TCI states from the configured TCI states and DCI indicates one of the more than one TCI states activated by MAC CE.

### AI/ML

In 3GPP Rel.18, AI (Artificial Intelligence) and/or ML (Machine Learning) based air interfere is going to be studied. As use cases, 1) CSI feedback enhancement (e.g., overhead reduction, improved accuracy, prediction) and 2) Beam management (e.g., beam prediction in time, and/or spatial domain for overhead and latency reduction, beam selection accuracy improvement) are considered.

The below description includes improvements relating to 3GPP framework for AI/ML for air-interface corresponding to each target use case regarding aspects such as performance, complexity, and potential specification impact.

### The Description Also Includes:

CSI feedback enhancement, e.g., overhead reduction, improved accuracy, prediction
Beam management, e.g., beam prediction in time, and/or spatial domain for overhead and latency reduction, beam selection accuracy improvement
Positioning accuracy enhancements for different scenarios including, e.g., those with heavy NLOS conditions

The description also includes representative sub use cases for each use case for characterization and baseline performance evaluations by RAN #98 including:
The AI/ML approaches for the selected sub use cases need to be diverse enough to support various requirements on the gNB-UE collaboration levels

The selection of use cases for this disclosure solely targets the formulation of a framework to apply AI/ML to the air-interface for these and other use cases. The selection itself does not intend to provide any indication of the prospects of any future normative project.

The AI/ML model, terminology and description to identify common and specific characteristics for framework investigations are described as follows:
Characterize the defining stages of AI/ML related algorithms and associated complexity:
   Model generation, e.g., model training (including input/output, pre-/postprocess, online/offline as applicable), model validation, model testing, as applicable
   Inference operation, e.g., input/output, pre-/post-process, as applicable
Identify various levels of collaboration between UE and gNB pertinent to the selected use cases, e.g.,
   No collaboration: implementation-based only AI/ML algorithms without information exchange [for comparison purposes]
   Various levels of UE/gNB collaboration targeting at separate or joint ML operation.
Characterize lifecycle management of AI/ML model: e.g., model training, model deployment, model inference, model monitoring, model updating
Dataset(s) for training, validation, testing, and inference.
Identify common notation and terminology for AI/ML related functions, procedures and interfaces

When appropriate, the work done for FS_NR_ENDC_data_collect may be considered.

### The Below Description Includes the Following for Certain Use Cases:

Evaluate performance benefits of AI/ML based algorithms for the agreed use cases in the final representative set:
   Methodology based on statistical models (from TR 38.901 and TR 38.857 [positioning]), for link and system level simulations.
      Extensions of 3GPP evaluation methodology for better suitability to AI/ML based techniques should be considered as needed.
      Whether field data are optionally needed to further assess the performance and robustness in real-world environments should be discussed.
      Need for common assumptions in dataset construction for training, validation and test for the selected use cases.
      Consider adequate model training strategy, collaboration levels and associated implications
      Consider agreed-upon base AI model(s) for calibration
      AI model description and training methodology used for evaluation should be reported for information and cross-checking purposes
   KPIs: Determine the common KPIs and corresponding requirements for the AI/ML operations. Determine the use-case specific KPIs and benchmarks of the selected use-cases.
      Performance, inference latency and computational complexity of AI/ML based algorithms should be compared to that of a state-of-the-art baseline
      Overhead, power consumption (including computational), memory storage, and hardware requirements (including for given processing delays) associated with enabling respective AI/ML scheme, as well as generalization capability should be considered.
Assess potential specification impact, specifically for the agreed use cases in the final representative set and for a common framework:
   PHY layer aspects, e.g., (RAN1)
      Consider aspects related to, e.g., the potential specification of the AI Model lifecycle management, and dataset construction for training, validation and test for the selected use cases
      Use case and collaboration level specific specification impact, such as new signaling, means for training and validation data assistance, assistance information, measurement, and feedback
      Protocol aspects, e.g., RAN2 only starts the work after there is sufficient progress on the use case study in RAN1
      Consider aspects related to, e.g., capability indication, configuration and control procedures (training/inference), and management of data and AI/ML model, per RAN1 input
      Collaboration level specific specification impact per use case
   Interoperability and testability aspects, e.g., RAN4 only starts the work after there is sufficient progress on use case study in RAN1 and RAN2
      Requirements and testing frameworks to validate AI/ML based performance enhancements and ensuring that UE and gNB with AI/ML meet or exceed the existing minimum requirements if applicable
      Consider the need and implications for AI/ML processing capabilities definition

The study on AI/ML for air interface is based on the current RAN architecture.

Background on Artificial Intelligence (AI)/Machine Learning (ML) for NR Air Interface

This description includes the benefits of augmenting the air-interface with features enabling improved support of AI/ML based algorithms for enhanced performance and/or reduced complexity/overhead. Enhanced performance here depends on the use cases under consideration and could be, e.g., improved throughput, robustness, accuracy or reliability, etc.

Through studying a few carefully selected use cases, assessing their performance in comparison with traditional methods and the associated potential specification impacts that enable their solutions, this will lay the foundation for future air-interface use cases leveraging AI/ML techniques.

One goal is that sufficient use cases will be considered to enable the identification of a common AI/ML framework, including functional requirements of AI/ML architecture, which could be used in subsequent projects. The disclosure should also identify areas where AI/ML could improve the performance of air-interface functions.

Aspects may identify what is required for an adequate AI/ML model characterization and description establishing pertinent notation for discussions and subsequent evaluations. Various levels of collaboration between the gNB and UE are identified and considered.

Evaluations to exercise the attainable gains of AI/ML based techniques for the use cases under consideration may be carried out with the corresponding identification of KPIs with a goal to have a better understanding of the attainable gains and associated complexity requirements.

Finally, specification impact may be assessed in order to improve the overall understanding of what would be required to enable AI/ML techniques for the air-interface.

The description of the terminologies for Artificial Intelligence (AI)/Machine Learning (ML) for NR Air Interface are shown as follows:
Data collection: A process of collecting data by the network nodes, management entity, or UE for the purpose of AI/ML model training, data analytics and inference.
AI/ML Model: A data driven algorithm that applies AI/ML techniques to generate a set of outputs based on a set of inputs.
AI/ML model training: A process to train an AI/ML Model by learning the input/output relationship in a data driven manner and obtain the trained AI/ML Model for inference.
AI/ML Inference: A process of using a trained AI/ML model to produce a set of outputs based on a set of inputs.
AI/ML model validation: A subprocess of training, to evaluate the quality of an AI/ML model using a dataset different from one used for model training, that helps selecting model parameters that generalize beyond the dataset used for model training.
AI/ML model testing: A subprocess of training, to evaluate the performance of a final AI/ML model using a dataset different from one used for model training and validation. Differently from AI/ML model validation, testing do not assume subsequent tuning of the model.
Online training: An AI/ML training process where the model being used for inference) is (typically continuously) trained in (near) real-time with the arrival of new training samples. It should be noted that the notion of (near) real-time vs. non real-time is context-dependent and is relative to the inference time-scale. It should be further noted that this definition only serves as a guidance. There may be cases that may not exactly conform to this definition but could still be categorized as online training by commonly accepted conventions. It should be further noted that fine-tuning/re-training may be done via online or offline training.
Offline training: An AI/ML training process where the model is trained based on collected dataset, and where the trained model is later used or delivered for inference. It should be noted that this definition only serves as a guidance. There may be cases that may not exactly conform to this definition but could still be categorized as offline training by commonly accepted conventions.
On-UE training: Online/offline training at the UE.
On-network training: Online/offline training at the network.
UE-side (AI/ML) model: An AI/ML Model whose inference is performed entirely at the UE.
Network-side (AI/ML) model: An AI/ML Model whose inference is performed entirely at the network.
One-sided (AI/ML) model: A UE-side (AI/ML) model or a Network-side (AI/ML) model.
Two-sided (AI/ML) model: A paired AI/ML Model(s) over which joint inference is performed, where joint inference comprises AI/ML Inference whose inference is performed jointly across the UE and the network, i.e., the first part of inference is firstly performed by UE and then the remaining part is performed by gNB, or vice versa.
Model transfer: Delivery of an AI/ML model over the air interface, either parameters of a model structure known at the receiving end or a new model with parameters. Delivery may contain a full model or a partial model.
Model download: Model transfer from the network to UE.
Model upload: Model transfer from UE to the network.
Model deployment: Delivery of a fully developed and tested model runtime image to a target UE/gNB where inference is to be performed.
AI/ML model delivery: A generic term referring to delivery of an AI/ML model from one entity to another entity in any manner. It should be noted that an entity could mean a network node/function (e.g., gNB, LMF, etc.), UE, proprietary server, etc.
Federated learning/federated training: A machine learning technique that trains an AI/ML model across multiple decentralized edge nodes (e.g., UEs, gNBs) each performing local model training using local data samples. The technique requires multiple model exchanges, but no exchange of local data samples.
Offline field data: The data collected from field and used for offline training of the AI/ML model.
Online (field) data: The data collected from field and used for online training of the AI/ML model.
Model monitoring: A procedure that monitors the inference performance of the AI/ML model.
Model update: Retraining or fine tuning of an AI/ML model, via online/offline training, to improve the model inference performance.
Supervised learning: A process of training a model from input and its corresponding labels.
Unsupervised learning: A process of training a model without labelled data e.g., clustering is a common example of this.
Semi-supervised learning: A process of training a model with a mix of labelled data and unlabelled data.
Reinforcement Learning (RL): A process of training an AI/ML model from input (a.k.a. state) and a feedback signal (a.k.a. reward) resulting from the model's output (a.k.a. action) in an environment the model is interacting with.

The following network-UE collaboration levels considered as one aspect for defining collaboration levels:
Level x: No collaboration
Level y: Signaling-based collaboration without model transfer
Level z: Signaling-based collaboration with model transfer

Other aspect(s), for defining collaboration levels is not precluded, e.g., with/without model updating, to support training/inference, for defining collaboration levels will be discussed in later meetings. Clarification for Level x-y boundary may be further studied.

The following aspects, including the definition of components (if needed) and necessity, may be considered in Life Cycle Management: Data collection (this also includes associated assistance information, if applicable); Model training; Model registration; Model deployment (this includes process of compiling a trained AI/ML model and packaging it into an executable format and delivering to a target device); Model configuration; Model inference operation; Model selection, activation, deactivation, switching, and fallback operation (some of them to be refined); Model monitoring; Model update (this includes model finetuning, retraining, and redevelopment via online/offline training); Model transfer; and UE capability.

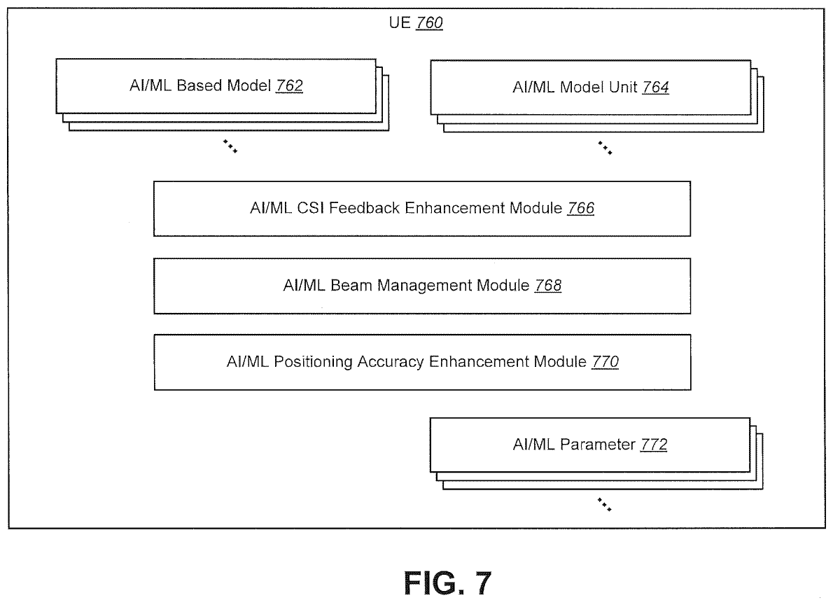

FIG. 7 is a block diagram of a UE 760 illustrating Artificial Intelligence (AI)/Machine Learning (ML) components. Further details regarding details of the functional blocks shown in FIG. 7 are provided herein below. The UE 760 may include AI/ML based models 762. The UE 760 may also include AI/ML model units 764. The UE 760 may also include an AI/ML CSI feedback enhancement module 766, an AI/ML beam management module 768, and an AI/ML positioning accuracy enhancement module 770. The UE 760 may also include AI/ML parameters 772.

### AI/ML for CSI Feedback Enhancement

Whether to support AI/ML for CSI predication (in time domain, frequency domain and/or spatial domain) or not may be a UE capability. A capability signaling may comprise a parameter 772 which indicates whether the UE 760 supports AI/ML for CSI predication (in time domain, frequency domain and/or spatial domain). Whether to apply/use/implement AI/ML for CSI predication (in time domain, frequency domain and/or spatial domain) or not may be configured/indicated by a common/dedicated/UE-specific RRC message/signaling and/or SI and/or indicated by L2 signaling (e.g., MAC CE) and/or L1 signaling (e.g., DCI, PDCCH).

Whether to support one-sided (AI/ML) model 762 for CSI predication (in time domain, frequency domain and/or spatial domain) or not may be a UE capability. A capability signaling may comprise a parameter 772 which indicates whether the UE 760 supports one-sided (AI/ML) model 762 for CSI predication (in time domain, frequency domain and/or spatial domain). Whether to apply/use/implement one-sided (AI/ML) model 762 for CSI predication (in time domain, frequency domain and/or spatial domain) or not may be configured/indicated by a common/dedicated/UE-specific RRC message/signaling and/or SI and/or indicated by L2 signaling (e.g., MAC CE) and/or L1 signaling (e.g., DCI, PDCCH). Any of the parameters described herein are represented by the AI/ML parameter 772 shown in FIG. 7.

Whether to support two-sided (AI/ML) model 762 for CSI predication (in time domain, frequency domain and/or spatial domain) or not may be a UE capability. A capability signaling may comprise a parameter 772 which indicates whether the UE 760 supports two-sided (AI/ML) model 762 for CSI predication (in time domain, frequency domain and/or spatial domain). Whether to apply/use/implement two-sided (AI/ML) model 762 for CSI predication (in time domain, frequency domain and/or spatial domain) or not may be configured/indicated by a common/dedicated/UE-specific RRC message/signaling and/or SI and/or indicated by L2 signaling (e.g., MAC CE) and/or L1 signaling (e.g., DCI, PDCCH).

Whether to support AI/ML for CSI predication (in time domain, frequency domain and/or spatial domain) with or without network-UE collaboration may be a UE capability. A capability signaling may comprise a parameter 772 which indicates whether the UE 760 supports AI/ML for CSI predication (in time domain, frequency domain and/or spatial domain) with or without network-UE collaboration. Whether to apply/use/implement AI/ML for CSI predication (in time domain, frequency domain and/or spatial domain) with or without network-UE collaboration may be configured/indicated by a common/dedicated/UE-specific RRC message/signaling and/or SI and/or indicated by L2 signaling (e.g., MAC CE) and/or L1 signaling (e.g., DCI, PDCCH).

Whether to support AI/ML for CSI predication (in time domain, frequency domain and/or spatial domain) with network-UE collaboration level y (i.e., signaling-based collaboration without model transfer) or not may be a UE capability. A capability signaling may comprise a parameter 772 which indicates whether the UE 760 supports AI/ML for CSI predication (in time domain, frequency domain and/or spatial domain) with network-UE collaboration level y (i.e., signaling-based collaboration without model transfer) or not. Whether to apply/use/implement AI/ML for CSI predication (in time domain, frequency domain and/or spatial domain) with network-UE collaboration level y (i.e., signaling-based collaboration without model transfer) or not may be configured/indicated by a common/dedicated/UE-specific RRC message/signaling and/or SI and/or indicated by L2 signaling (e.g., MAC CE) and/or L1 signaling (e.g., DCI, PDCCH).

Whether to support AI/ML for CSI predication (in time domain, frequency domain and/or spatial domain) with network-UE collaboration level z (i.e., signaling-based collaboration with model transfer) or not may be a UE capability. A capability signaling may comprise a parameter 772 which indicates whether the UE supports AI/ML for CSI predication (in time domain, frequency domain and/or spatial domain) with network-UE collaboration level z (i.e., signaling-based collaboration with model transfer) or not. Whether to apply/use/implement AI/ML for CSI predication (in time domain, frequency domain and/or spatial domain) with network-UE collaboration level z (i.e., signaling-based collaboration with model transfer) or not may be configured/indicated by a common/dedicated/UE-specific RRC message/signaling and/or SI and/or indicated by L2 signaling (e.g., MAC CE) and/or L1 signaling (e.g., DCI, PDCCH).

Whether to support AI/ML for CSI compression or not may be a UE capability. A capability signaling may comprise a parameter 772 which indicates whether the UE 760 supports AI/ML for CSI compression. Whether to apply/use/implement AI/ML for CSI compression or not may be configured/indicated by a common/dedicated/UE-specific RRC message/signaling and/or SI and/or indicated by L2 signaling (e.g., MAC CE) and/or L1 signaling (e.g., DCI, PDCCH).

Whether to support one-sided (AI/ML) model for CSI compression or not may be a UE capability. A capability signaling may comprise a parameter 772 which indicates whether the UE supports one-sided (AI/ML) model 764 for CSI compression. Whether to apply/use/implement one-sided (AI/ML) model 764 for CSI compression or not may be configured/indicated by a common/dedicated/UE-specific RRC message/signaling and/or SI and/or indicated by L2 signaling (e.g., MAC CE) and/or L1 signaling (e.g., DCI, PDCCH).

Whether to support two-sided (AI/ML) model for CSI compression or not may be a UE capability. A capability signaling may comprise a parameter 772 which indicates whether the UE 760 supports two-sided (AI/ML) model for CSI compression. Whether to apply/use/implement two-sided (AI/ML) model for CSI compression or not may be configured/indicated by a common/dedicated/UE-specific RRC message/signaling and/or SI and/or indicated by L2 signaling (e.g., MAC CE) and/or L1 signaling (e.g., DCI, PDCCH).

Whether to support AI/ML for CSI compression with or without network-UE collaboration may be a UE capability. A capability signaling may comprise a parameter 772 which indicates whether the UE 760 supports AI/ML for CSI compression with or without network-UE collaboration. Whether to apply/use/implement AI/ML for CSI compression with or without network-UE collaboration may be configured/indicated by a common/dedicated/UE-specific RRC message/signaling and/or SI and/or indicated by L2 signaling (e.g., MAC CE) and/or L1 signaling (e.g., DCI, PDCCH).

Whether to support AI/ML for CSI compression with network-UE collaboration level y (i.e., signaling-based collaboration without model transfer) or not may be a UE capability. A capability signaling may comprise a parameter 772 which indicates whether the UE 760 supports AI/ML for CSI compression with network-UE collaboration level y (i.e., signaling-based collaboration without model transfer) or not. Whether to apply/use/implement AI/ML for CSI compression with network-UE collaboration level y (i.e., signaling-based collaboration without model transfer) or not may be configured/indicated by a common/dedicated/UE-specific RRC message/signaling and/or SI and/or indicated by L2 signaling (e.g., MAC CE) and/or L1 signaling (e.g., DCI, PDCCH).

Whether to support AI/ML for CSI compression with network-UE collaboration level z (i.e., signaling-based collaboration with model transfer) or not may be a UE capability. A capability signaling may comprise a parameter 772 which indicates whether the UE supports AI/ML for CSI compression with network-UE collaboration level z (i.e., signaling-based collaboration with model transfer) or not. Whether to apply/use/implement AI/ML for CSI compression with network-UE collaboration level z (i.e., signaling-based collaboration with model transfer) or not may be configured/indicated by a common/dedicated/UE-specific RRC message/signaling and/or SI and/or indicated by L2 signaling (e.g., MAC CE) and/or L1 signaling (e.g., DCI, PDCCH).

A maximum number of AI/ML model units 764 (e.g., memory storage(s) for AI/ML model(s), AI/ML model size(s), AI/ML parameter payload size(s), AI/ML model parameter(s)) may be a UE capability. A capability signaling may comprise a parameter 772 which indicates the number of AI/ML model units 764 (e.g., memory storage(s) for AI/ML model(s), AI/ML model size(s), AI/ML parameter payload size(s), AI/ML model parameter(s)) for which the UE 760 can implement/apply/use/store simultaneously for which this capability is provided. Whether to apply/use/implement the maximum number of AI/ML model units 764 (e.g., memory storage(s) for AI/ML model(s), AI/ML model size(s), AI/ML parameter payload size(s), AI/ML model parameter(s)) may be configured/indicated by a common/dedicated/UE-specific RRC message/signaling and/or SI and/or indicated by L2 signaling (e.g., MAC CE) and/or L1 signaling (e.g., DCI, PDCCH).

A maximum number of AI/ML model units 764 (e.g., memory storage(s) for AI/ML model(s), AI/ML model size(s), AI/ML parameter payload size(s), AI/ML model parameter(s)) for CSI feedback enhancement (CSI prediction and/or CSI compression) may be a UE capability. A capability signaling (e.g., csi-ReportFramework, csi-ReportFrameworkExt-AIML) may comprise a parameter 772 (e.g., simultaneousCSI-Reports-AIML) which indicates the number of AI/ML model units 764 (e.g., memory storage(s) for AI/ML model(s), AI/ML model size(s), AI/ML parameter payload size(s), AI/ML model parameter(s)) for which the UE can implement/apply/use/store simultaneously for which this capability is provided. Whether to apply/use/implement the maximum number of AI/ML model units 764 (e.g., memory storage(s) for AI/ML model(s), AI/ML model size(s), AI/ML parameter payload size(s), AI/ML model parameter(s)) for CSI feedback enhancement (CSI prediction and/or CSI compression) may be configured/indicated by a common/dedicated/UE-specific RRC message/signaling and/or SI and/or indicated by L2 signaling (e.g., MAC CE) and/or L1 signaling (e.g., DCI, PDCCH).

When the maximum number of AI/ML model units 764 (e.g., memory storage(s) for AI/ML model(s), AI/ML model size(s), AI/ML parameter payload size(s), AI/ML model parameter(s)) 772 has been reached, priority handling may be needed for managements of the associated AI/ML models, e.g., which AI/ML model(s) to be prioritized/applied/used/adopted. The priority of AI/ML model(s) may be determined by AI/ML use case (e.g., AI/ML for CSI feedback enhancement 766, AI/ML for beam management 768, AI/ML for positioning accuracy enhancement 770), memory storage(s) for AI/ML model(s), AI/ML model size(s), AI/ML parameter payload size(s), AI/ML model parameter(s) 772 and so on. For example, AI/ML models may be associated with a priority value

$${Pri}_{iAIML} .$$

### The Priority Value

$${Pri}_{iAIML}$$

may be determined by AI/ML use case (e.g., AI/ML for CSI feedback enhancement 766, AI/ML for beam management 768, AI/ML for positioning accuracy enhancement 770), memory storage(s) for AI/ML model(s), AI/ML model size(s), AI/ML parameter payload size(s), AI/ML model parameter(s) 772. A first AI/ML model is said to have priority over second AI/ML model if the associated

$${Pri}_{iAIML}$$

value is lower (higher) for the first AI/ML model than for the second AI/ML model. Two AI/ML model(s) are said to collide if the time occupancy of the AI/ML model units 764 are overlapped. When a UE is configured to use/apply/adopt two colliding AI/ML models, the AI/ML model with higher (lower)

$${Pri}_{iAIML}$$

value shall not be used/applied/adopted by the UE (gNB).

With the introduction of AI/ML for CSI feedback enhancement 766, the priority rules for CSI reports may be updated. Priority handling between CSI reports based on consideration of an indicator(s) or index (to indicate whether the CSI report is enabled/supported/utilized/activated with AI/ML for CSI feedback enhancement 766) is described here. For example, if the CSI report is not associated with AI/ML (or the CSI report a legacy CSI report, e.g., Rel-15/Rel-16/Rel-17 CSI report), the CSI report is with priority index 0. If the CSI report is enabled/supported/utilized/activated with AI/ML for CSI feedback enhancement 766, the CSI report is with priority index 1.

In an implementation, based on a value(s) of a priority indicator(s) or priority index, SP-CSI (i.e., activated by DCI format including a priority indicator (priority index) set to “1”) is prioritized over A-CSI (i.e., scheduled by DCI format including a priority indicator (priority index) set to “0”). For example, a UE may perform semi-persistent CSI (SP-CSI) reporting on the PUSCH upon successful decoding of a DCI format 0_1 or DCI format 0_2 which activates a semi-persistent CSI trigger state and priority index provided by priority indicator field in the DCI format 0_1 or DCI format 0_2 is set to “1” (referred to as SP-CSI report with priority index 1 in the disclosure). A UE 760 may also perform aperiodic CSI (A-CSI) reporting using PUSCH on a serving cell upon successful decoding of a DCI format 0_1 or DCI format 0_2 which triggers an aperiodic CSI trigger state and priority index provided by priority indicator field in the DCI format 0_1 or DCI format 0_2 is set to “0” (referred TO as A-CSI report with priority index 0 in the disclosure). The SP-CSI report with priority index 1 may have priority over the A-CSI report with priority index 0. If the SP-CSI report with priority index 1 and the A-CSI report with priority index 0 collide if the time occupancy of the physical channels scheduled to carry the CSI reports overlap in at least one OFDM symbol and are transmitted on the same carrier, the A-CSI report with priority index 0 may not be sent by the UE. The priority handling behavior described here may be RRC configured. For example, if an RRC parameter (e.g., SP-CSI_priority_enabler) is configured and/or set as a value indicating the priority handling behavior is enabled, the SP-CSI report with priority index 1 may have priority over the A-CSI report with priority index 0.

In yet another implementation, regardless of a value(s) of a priority indicator(s) or priority index, A-CSI (i.e., scheduled by DCI format including a priority indicator set to “0”) is prioritized over SP-CSI (i.e., activated by DCI format including a priority indicator set to “1”). For example, an aperiodic CSI (A-CSI) reporting using PUSCH may be scheduled by a DCI format 0_1 or DCI format 0_2 which triggers an aperiodic CSI trigger state, no matter whether priority index is provided in the DCI format or not, and/or no matter what value is set to the priority index. If a SP-CSI report activated by a DCI format with or without priority index (no matter what value the priority index is if provided) and the A-CSI report collide if the time occupancy of the physical channels scheduled to carry the CSI reports overlap in at least one OFDM symbol and are transmitted on the same carrier, the SP-CSI report may not be sent by the UE. The priority handling behavior described here may be RRC configured. For example, if an RRC parameter (e.g., A-CSI_priority_enabler) is configured and/or set as a value indicating the priority handling behavior is enabled, the A-CSI report may have priority over the SP-CSI report regardless of a value(s) of a priority indicator(s) or priority index.

In yet another implementation, a new factor (e.g., p) considering a value(s) of a priority indicator(s) is added into the equation for the priority rule of CSI report. Namely, a new function/equation “Pr” “i”_iCSI (p,y,k,c,s) may be used for the priority rule of the CSI report, where for aperiodic CSI reports to be carried on PUSCH for semi-persistent CSI reports to be carried on PUSCH, for semi-persistent CSI reports to be carried on PUCCH and for periodic CSI reports to be carried on PUCCH; for CSI reports carrying L1-RSRP or L1-SINR and for CSI reports not carrying L1-RSRP or L1-SINR; c is the serving cell index and is the value of the higher layer parameter maxNrofServingCells; s is the reportConfigID and is the value of the higher layer parameter maxNrofCSI-ReportConfigurations; p is determined by the priority index provided by the DCI format (e.g., DCI format 0_1 and/or DCI format 0_2) scheduling A-CSI reporting and/or activation SP-CSI (e.g., p=1 (or p=0) if the priority index is 1, p=0 (or p=1) if the priority index is 0, p=0 (or p=1) if the priority index is not provided). A first CSI report may have priority over second CSI report if the associated value is lower (or higher) for the first report than for the second report. Two CSI reports are said to collide if the time occupancy of the physical channels scheduled to carry the CSI reports overlap in at least one OFDM symbol and are transmitted on the same carrier. When a UE is configured to transmit two colliding CSI reports, the CSI report with higher (or lower) value may not be sent by the UE. Details of the new function/equation are described here. For example,

$${Pri}_{iCSI} ( p , y , k , c , s ) = 2 \cdot {N}_{cells} \cdot {M}_{s} \cdot y + {N}_{cells} \cdot {M}_{s} \cdot k + {M}_{s} \cdot c + s + p \cdot scale ,$$

where scale may be an indicated, configured and/or fixed value in the spec and/or determined by other parameter(s) and the scale can be any value (e.g., a positive value such as 1, 2, 3, a negative value −1, −2, −3, −3.6, etc.). In yet another example,

$${Pri}_{iCSI} ( p , y , k , c , s ) = 2 \cdot {N}_{cells} \cdot {M}_{s} \cdot ( y + p \cdot scale ) + {N}_{cells} \cdot {M}_{s} \cdot k + {M}_{s} \cdot c + s ,$$

where scale may be indicated/configured/fixed value in the spec and/or determined by other parameter(s) and the scale can be any value (e.g., a positive value such as 1, 2, 3, a negative value −1, −2, −3, −3.6, etc.).

For a case where A-CSI and SP-CSI are with the same priority index or the priority index is not provided, A-CSI may be prioritized over SP-CSI. For example, if the SP-CSI report with priority index 1 (or 0) and the A-CSI report with the same priority index 1 (or 0) collide if the time occupancy of the physical channels scheduled to carry the CSI reports overlap in at least one OFDM symbol and are transmitted on the same carrier, the SP-CSI report may not be sent by the UE.

Priority handling between SP-CSI and UL-SCH based on consideration of a priority indicator(s) is also described herein.

In an implementation, based on a value(s) of a priority indicator(s), SP-CSI (i.e., activated by DCI format including a priority indicator set to “1”) may be prioritized over UL-SCH (i.e., scheduled by DCI format including a priority indicator set to “0”). For example, a UE may perform semi-persistent CSI (SP-CSI) reporting on the PUSCH upon successful decoding of a DCI format 0_1 or DCI format 0_2 which activates a semi-persistent CSI trigger state and priority index provided by priority indicator field in the DCI format 0_1 or DCI format 0_2 is set to “1” (referred to as SP-CSI report with priority index 1 in the disclosure). A UE 760 may also perform ULSCH using PUSCH upon successful decoding of a DCI format 0_1 or DCI format 0_2 which includes priority indicator field set to “0” (referred to as UL-SCH with priority index 0 in the disclosure). The SP-CSI report with priority index 1 may have priority over the UL-SCH with priority index 0. If the SP-CSI report with priority index 1 and the UL-SCH with priority index 0 collide if the time occupancy of the physical channels scheduled to carry the CSI report(s) and/or UL-SCH overlap in at least one OFDM symbol and are transmitted on the same carrier, the UL-SCH with priority index 0 may not be sent by the UE. The priority handling behavior described herein may be RRC configured. For example, if an RRC parameter 772 (e.g., SP-CSI_priority_enabler) is configured and/or set as a value indicating the priority handling behavior is enabled, the SP-CSI report with priority index 1 is said to have priority over the UL-SCH with priority index 0.

In yet another implementation, regardless of a value(s) of a priority indicator(s), ULSCH (i.e., scheduled by DCI format including a priority indicator set to “0”) may be prioritized over SP-CSI (i.e., activated by DCI format including a priority indicator set to “1”). For example, an UL-SCH using PUSCH may be scheduled by a DCI format 0_1 or DCI format 0_2, no matter whether a priority index is provided in the DCI format or not, and/or no matter what value is set to the priority index. If a SP-CSI report activated by a DCI format with or without priority index (no matter what value the priority index is if provided) and the UL-SCH collide if the time occupancy of the physical channels scheduled to carry the CSI report(s) and/or UL-SCH overlap in at least one OFDM symbol and are transmitted on the same carrier, the SP-CSI report may not be sent by the UE 760. The priority handling behavior described herein may be RRC configured. For example, if an RRC parameter (e.g., ULSCH_priority_enabler) is configured and/or set as a value indicating the priority handling behavior is enabled, the UL-SCH may have priority over the SP-CSI report regardless of a value(s) of a priority indicator(s) or priority index.

For a case where the same priority or without the priority, UL-SCH is prioritized over SP-CSI. For example, if the SP-CSI report with priority index 1 (or 0) and the UL-SCH with same priority index 1 (or 0) are said to collide if the time occupancy of the physical channels scheduled to carry the CSI report(s) and/or UL-SCH overlap in at least one OFDM symbol and are transmitted on the same carrier, the SP-CSI report may not be sent by the UE.

For SP-CSI transmission without UL-SCH, the first actual repetition may be used.

Any combination(s) of the priority handling between A-CSI and SP-CSI as described above and the priority handling between SP-CSI and UL-SCH as described above may be applied.

For example, SP-CSI may be prioritized over A-CSI as described above, and SP-CSI may be prioritized over UL-SCH as described. In this case, A-CSI may be prioritized over UL-SCH. Namely, SP-CSI is prioritized over A-CSI which is prioritized over ULSCH.

Additionally or alternatively, SP-CSI may be prioritized over A-CSI as described above, and UL-SCH may be prioritized over SP-CSI as described. In this case, A-CSI may be prioritized over UL-SCH. Namely, SP-CSI is prioritized over A-CSI which is prioritized over UL-SCH.

Additionally or alternatively, A-CSI may be prioritized over SP-CSI as described above, and SP-CSI may be prioritized over UL-SCH as described. Namely, A-CSI is prioritized over SP-CSI which is prioritized over UL-SCH. Additionally or alternatively, A-CSI may be prioritized over SP-CSI as described above, and UL-SCH may be prioritized over SP-CSI as described. Namely, A-CSI is prioritized over UL-SCH which is prioritized over SP-CSI.

For example, regardless of the value(s) of the priority indicator(s), A-CSI may be always prioritized over SP-CSI as described above. Also, A-CSI may be always prioritized over UL-SCH as described above. And, the priority handling between SP-CSI and UL-SCH may be applied (e.g., determined) based on the value(s) of the priority indicator(s) as described above. Namely, SP-CSI may be prioritized over UL-SCH based on the value(s) of the priority indicator(s) (i.e., A-CSI may be prioritized over SP-CSI which is prioritized over UL-SCH). Also, UL-SCH may be prioritized over SP-CSI based on the value(s) of the priority indicator(s) (i.e., A-CSI may be prioritized over UL-SCH which is prioritized over SP-CSI). Namely, A-CSI may be always prioritized over SP-CSI and UL-SCH. Namely, regardless of the value(s) of the priority indicator(s), A-CSI may be always prioritized over SP-CSI and UL-SCH. And, the priority handling based on the value(s) of the priority indicator(s) may be applied between SP-CSI and UL-SCH. Namely, the priority indicator(s) (e.g., the value(s) of the priority indicator(s)) may not be applied for A-CSI (i.e., A-CSI reporting). Namely, the UE 760 may not apply the priority indicator(s) (e.g., the value(s) of the priority indicator(s)) for A-CSI (i.e., A-CSI reporting).

A separate set of periodicities (or an AI/ML-specific periodicity) for CSI-RS configuration(s) may be configured for UE with AI/ML for CSI feedback enhancement by RRC. For example, when a UE is enabled/activated with AI/ML for CSI feedback enhancement, UE may measure CSI-RS based on the configured/provided AI/ML-specific configuration (e.g., periodicity).

A separate set of periodicities (or an AI/ML-specific periodicity) for CSI reporting may be configured for UE 760 with AI/ML for CSI feedback enhancement 766 by RRC. For example, when a UE is enabled/activated with AI/ML for CSI feedback enhancement 766, UE 760 may report CSI based on the configured/provided AI/ML-specific configuration (e.g., periodicity).

To support AI/ML for CSI feedback enhancement 766, a new CSI quantity (or multiple new CSI quantities), other than existing (Rel-15, Rel-16, Rel-17) quantities such as rank indicator, layer indicator, channel quality indicator, precoding matrix indicator, CSI-RS resource indicator and so on, may be introduced in a CSI report. For example, a new CSI quantity may be an AI/ML model related parameter(s) 772. In yet another example, a new CSI quantity may be compressed CSI. In yet another example, a new CSI quantity may be indication of AI/ML related model/parameter from a set of models/parameters. In yet another example, a new CSI quantity may be a quantized CSI parameter/quantity. Then newly introduced CSI quantity may depend on model input or model output, Delta-MCS/CQI/CSI and/or Type III codebook.

### AI/ML for Beam Management

Whether to support AI/ML for beam predication/selection 768 (in time domain, frequency domain and/or spatial domain) or not may be a UE capability. A capability signaling may comprise a parameter 772 which indicates whether the UE 760 supports AI/ML for beam predication/selection (in time domain, frequency domain and/or spatial domain). Whether to apply/use/implement AI/ML for beam predication/selection (in time domain, frequency domain and/or spatial domain) or not may be configured/indicated by a common/dedicated/UE-specific RRC message/signaling and/or SI and/or indicated by L2 signaling (e.g., MAC CE) and/or L1 signaling (e.g., DCI, PDCCH).

Whether to support one-sided (AI/ML) model for beam predication/selection (in time domain, frequency domain and/or spatial domain) or not may be a UE capability. A capability signaling may comprise a parameter which indicates whether the UE 760 supports one-sided (AI/ML) model for beam predication/selection (in time domain, frequency domain and/or spatial domain). Whether to apply/use/implement one-sided (AI/ML) model for beam predication/selection (in time domain, frequency domain and/or spatial domain) or not may be configured/indicated by a common/dedicated/UE-specific RRC message/signaling and/or SI and/or indicated by L2 signaling (e.g., MAC CE) and/or L1 signaling (e.g., DCI, PDCCH).

Whether to support two-sided (AI/ML) model 760 for beam predication/selection (in time domain, frequency domain and/or spatial domain) or not may be a UE capability. A capability signaling may comprise a parameter which indicates whether the UE 760 supports two-sided (AI/ML) model 760 for beam predication/selection (in time domain, frequency domain and/or spatial domain). Whether to apply/use/implement two-sided (AI/ML) model for beam predication/selection (in time domain, frequency domain and/or spatial domain) or not may be configured/indicated by a common/dedicated/UE-specific RRC message/signaling and/or SI and/or indicated by L2 signaling (e.g., MAC CE) and/or L1 signaling (e.g., DCI, PDCCH).

Whether to support AI/ML for beam predication/selection (in time domain, frequency domain and/or spatial domain) with or without network-UE collaboration may be a UE capability. A capability signaling may comprise a parameter which indicates whether the UE 760 supports AI/ML for beam predication/selection (in time domain, frequency domain and/or spatial domain) with or without network-UE collaboration. Whether to apply/use/implement AI/ML for beam predication/selection (in time domain, frequency domain and/or spatial domain) with or without network-UE collaboration may be configured/indicated by a common/dedicated/UE-specific RRC message/signaling and/or SI and/or indicated by L2 signaling (e.g., MAC CE) and/or L1 signaling (e.g., DCI, PDCCH).

Whether to support AI/ML for beam predication/selection (in time domain, frequency domain and/or spatial domain) with network-UE collaboration level y (i.e., signaling-based collaboration without model transfer) or not may be a UE capability. A capability signaling may comprise a parameter which indicates whether the UE 760 supports AI/ML for beam predication/selection (in time domain, frequency domain and/or spatial domain) with network-UE collaboration level y (i.e., signaling-based collaboration without model transfer) or not. Whether to apply/use/implement AI/ML for beam predication/selection (in time domain, frequency domain and/or spatial domain) with network-UE collaboration level y (i.e., signaling-based collaboration without model transfer) or not may be configured/indicated by a common/dedicated/UE-specific RRC message/signaling and/or SI and/or indicated by L2 signaling (e.g., MAC CE) and/or L1 signaling (e.g., DCI, PDCCH).

Whether to support AI/ML for beam predication/selection (in time domain, frequency domain and/or spatial domain) with network-UE collaboration level z (i.e., signaling-based collaboration with model transfer) or not may be a UE capability. A capability signaling may comprise a parameter which indicates whether the UE 760 supports AI/ML for beam predication/selection (in time domain, frequency domain and/or spatial domain) with network-UE collaboration level z (i.e., signaling-based collaboration with model transfer) or not. Whether to apply/use/implement AI/ML for beam predication/selection (in time domain, frequency domain and/or spatial domain) with network-UE collaboration level z (i.e., signaling-based collaboration with model transfer) or not may be configured/indicated by a common/dedicated/UE-specific RRC message/signaling and/or SI and/or indicated by L2 signaling (e.g., MAC CE) and/or L1 signaling (e.g., DCI, PDCCH).

A maximum number of AI/ML model units 764 (e.g., memory storage(s) for AI/ML model(s), AI/ML model size(s), AI/ML parameter payload size(s), AI/ML model parameter(s)) for beam management (beam prediction and/or beam selection) may be a UE capability. A capability signaling (e.g., BMFramework, BMFrameworkExt-AIML) may comprise a parameter (e.g., simultaneousBM-AIML) which indicates the number of AI/ML model units (e.g., memory storage(s) for AI/ML model(s), AI/ML model size(s), AI/ML parameter payload size(s), AI/ML model parameter(s)) 772 for which the UE 760 can implement/apply/use/store simultaneously for which this capability is provided. Whether to apply/use/implement the maximum number of AI/ML model units (e.g., memory storage(s) for AI/ML model(s), AI/ML model size(s), AI/ML parameter payload size(s), AI/ML model parameter(s)) 772 for beam management 768 (beam prediction and/or beam selection) may be configured/indicated by a common/dedicated/UE-specific RRC message/signaling and/or SI and/or indicated by L2 signaling (e.g., MAC CE) and/or L1 signaling (e.g., DCI, PDCCH).

A new (separate, AI/ML-specific) (set of) CSI-RS/SSB resource(s) may be RRC configured for AI/ML enabled beam management 768. The (set of) CSI-RS/SSB resource(s) may be a subset of existing configured CSI-RS/SSB resource(s). For example, when the UE 760 is enabled/activated with AI/ML for beam management 768, the UE 760 may measure the corresponding (set of) CSI-RS/SSB resource(s) configured/selected for AI/ML enabled beam management and feedback/apply/use for beam predication/selection.

For spatial-domain beam prediction, the best beam within Set A of beams may be selected based on the measurement of all RS resources or all possible beams of beam Set A (exhaustive beam sweeping). In yet another design, the best beam within Set A of beams may be selected based on the measurement of RS resources from Set B of beams. Set B may be a subset of Set A and/or Set A consists of narrow beams and Set B consists of wide beams. Set A and/or Set B may be configured/indicated by a common/dedicated/UE-specific RRC message/signaling and/or SI and/or indicated by L2 signaling (e.g., MAC CE) and/or L1 signaling (e.g., DCI, PDCCH).

For temporal beam prediction, the best beam for T2 within Set A of beams may be selected based on the measurements of all the RS resources or all possible beams from Set A of beams at the time instants within T2. In yet another design, the best beam for T2 within Set A of beams may be selected based on the measurements of all the RS resources from Set B of beams at the time instants within T1. T2 is the time duration for the best beam selection, and T1 is a time duration to obtain the measurements of all the RS resource from Set B of beams. T1 and T2 may be aligned with those for AI/ML based methods. T1 and/or T2 may be configured/indicated by a common/dedicated/UE-specific RRC message/signaling and/or SI and/or indicated by L2 signaling (e.g., MAC CE) and/or L1 signaling (e.g., DCI, PDCCH). Set A and Set B may the same or different. Set A and/or Set B may be configured/indicated by a common/dedicated/UE-specific RRC message/signaling and/or SI and/or indicated by L2 signaling (e.g., MAC CE) and/or L1 signaling (e.g., DCI, PDCCH).

For AI/ML-based beam management 768, spatial-domain DL beam prediction for Set A of beams based on measurement results of Set B of beams may be supported. AI/ML inference may be done at NW side and/or UE side. Set B may a subset of Set A. the number of beams in Set A and B may be configured/indicated by a common/dedicated/UE-specific RRC message/signaling and/or SI and/or indicated by L2 signaling (e.g., MAC CE) and/or L1 signaling (e.g., DCI, PDCCH). In yet another design, Set A and Set B may be different (e.g., Set A consists of narrow beams and Set B consists of wide beams). The number of beams in Set A and B may be configured/indicated by a common/dedicated/UE-specific RRC message/signaling and/or SI and/or indicated by L2 signaling (e.g., MAC CE) and/or L1 signaling (e.g., DCI, PDCCH). QCL relation between beams in Set A and beams in Set B may be configured/indicated by a common/dedicated/UE-specific RRC message/signaling and/or SI and/or indicated by L2 signaling (e.g., MAC CE) and/or L1 signaling (e.g., DCI, PDCCH). Set A is for DL beam prediction and Set B is for DL beam measurement. Measurement(s) on Set B may be used for AI/ML input(s). The measurement(s) may be L1-RSRP measurement based on Set B. Additionally or alternatively, the measurement(s) may be L1-RSRP measurement based on Set B and assistance information (e.g., Tx and/or Rx beam shape information (e.g., Tx and/or Rx beam pattern, Tx and/or Rx beam boresight direction (azimuth and elevation), 3 dB beamwidth, etc.), expected Tx and/or Rx beam for the prediction (e.g., expected Tx and/or Rx angle, Tx and/or Rx beam ID for the prediction), UE position information, UE direction information, Tx beam usage information, UE orientation information, etc.). Additionally or alternatively, the measurement(s) may be CIR based on Set B. Additionally or alternatively, the measurement(s) may be L1-RSRP measurement based on Set B and the corresponding DL Tx and/or Rx beam ID. Which measurement(s) to be used for AI/ML input may be configured/indicated by a common/dedicated/UE-specific RRC message/signaling and/or SI and/or indicated by L2 signaling (e.g., MAC CE) and/or L1 signaling (e.g., DCI, PDCCH).

For AI/ML-based beam management 768, temporal DL beam prediction for Set A of beams based on the historic measurement results of Set B of beams may be supported. The measurement results of K (K>=1) latest measurement instances may be used for AI/ML model input. The value of K may be configured/indicated by a common/dedicated/UE-specific RRC message/signaling and/or SI and/or indicated by L2 signaling (e.g., MAC CE) and/or L1 signaling (e.g., DCI, PDCCH). AI/ML model output should be F (F>=1) predictions for F future time instances, where each prediction is for each time instance. The value of F may be configured/indicated by a common/dedicated/UE-specific RRC message/signaling and/or SI and/or indicated by L2 signaling (e.g., MAC CE) and/or L1 signaling (e.g., DCI, PDCCH). AI/ML inference may be done at NW side and/or UE side. Set A and Set B may be different (e.g. Set A consists of narrow beams and Set B consists of wide beams). QCL relation between beams in Set A and beams in Set B may be configured/indicated by a common/dedicated/UE-specific RRC message/signaling and/or SI and/or indicated by L2 signaling (e.g., MAC CE) and/or L1 signaling (e.g., DCI, PDCCH). In yet another design, Set B is a subset of Set A (Set A and Set B are not the same). How to determine Set B out of the beams in Set A may follow a fixed pattern, random pattern, etc. A pattern(s) for determination of Set B out of the beams in Set A may be configured/indicated by a common/dedicated/UE-specific RRC message/signaling and/or SI and/or indicated by L2 signaling (e.g., MAC CE) and/or L1 signaling (e.g., DCI, PDCCH). In yet another design, Set A and Set B may be the same. Predicted beam(s) are selected from Set A and measured beams used as input are selected from Set B. Measurement(s) on Set B may be used for AI/ML input(s) (for each past measurement instance). The measurement(s) may be L1-RSRP measurement based on Set B. Additionally or alternatively, the measurement(s) may be L1-RSRP measurement based on Set B and assistance information (e.g., Tx and/or Rx beam angle, position information, UE direction information, positioning-related measurement (such as Multi-RTT), expected Tx and/or Rx beam/occasion for the prediction (e.g., expected Tx and/or Rx beam angle for the prediction, expected occasions of the prediction), Tx and/or Rx beam shape information (e.g., Tx and/or Rx beam pattern, Tx and/or Rx beam boresight directions (azimuth and elevation), 3 dB beamwidth, etc.), increase ratio of L1-RSRP for best N beams, UE orientation information). Additionally or alternatively, the measurement(s) may be: L1-RSRP measurement based on Set B and the corresponding DL Tx and/or Rx beam ID. Which measurement(s) to be used for AI/ML input may be configured/indicated by a common/dedicated/UE-specific RRC message/signaling and/or SI and/or indicated by L2 signaling (e.g., MAC CE) and/or L1 signaling (e.g., DCI, PDCCH).

How UE know Set A and set B may be associated with TCI state configurations/activations/indications. For this purpose, a gNB may configure transmission configuration indication (TCI) states to a UE. A TCI state may include: One or more reference resource indices; and/or QCL type for each of the one or more reference resource indices. An TCI state table(s)/list(s) may be RRC configured for set A and/or Set B. For example, a first TCI state table/list is configurated for Set A by a RRC message/signaling and a second TCI state table/list is configurated for Set B by a RRC message/signaling. In yet another example, an TCI state table/list may be configured by a RRC message/signaling. MAC CE may activate a first subset of the TCI state table/list for Set A and MAC CE may activate a second subset of the TCI state table/list for Set B.

AI/ML output for beam management 768 may be Tx and/or Rx Beam ID(s) and/or the predicted L1-RSRP of the N predicted DL Tx and/or Rx beams. For example, N predicted beams can be the top-N predicted beams. N may be a UE capability. A capability signaling may comprise a parameter which indicates the number of predicted beams can implement/apply/use/store simultaneously for which this capability is provided. Whether to apply/use/implement the number of beams may be configured/indicated by a common/dedicated/UE-specific RRC message/signaling and/or SI and/or indicated by L2 signaling (e.g., MAC CE) and/or L1 signaling (e.g., DCI, PDCCH). In yet another design, AI/ML output for beam management may be Tx and/or Rx Beam ID(s) of the N predicted DL Tx and/or Rx beams and other information (e.g., probability for the beam to be the best beam, the associated confidence, beam application time/dwelling time, Predicted Beam failure). For example, N predicted beams can be the top-N predicted beams. N may be a UE capability. A capability signaling may comprise a parameter which indicates the number of predicted beams can implement/apply/use/store simultaneously for which this capability is provided. Whether to apply/use/implement the number of beams may be configured/indicated by a common/dedicated/UE-specific RRC message/signaling and/or SI and/or indicated by L2 signaling (e.g., MAC CE) and/or L1 signaling (e.g., DCI, PDCCH). In yet another design, AI/ML output for beam management may be Tx and/or Rx Beam angle(s) and/or the predicted L1-RSRP of the N predicted DL Tx and/or Rx beams. For example, N predicted beams can be the top-N predicted beams. N may be a UE capability. A capability signaling may comprise a parameter which indicates the number of predicted beams can implement/apply/use/store simultaneously for which this capability is provided. Whether to apply/use/implement the number of beams may be configured/indicated by a common/dedicated/UE-specific RRC message/signaling and/or SI and/or indicated by L2 signaling (e.g., MAC CE) and/or L1 signaling (e.g., DCI, PDCCH). How to select the N DL Tx and/or Rx beams may follow a pattern (e.g., L1-RSRP higher than a threshold, a sum probability of being the best beams higher than a threshold, RSRP corresponding to the expected Tx and/or Rx beam direction(s)). A pattern(s) for determination of the N DL Tx and/or Rx beams may be configured/indicated by a common/dedicated/UE-specific RRC message/signaling and/or SI and/or indicated by L2 signaling (e.g., MAC CE) and/or L1 signaling (e.g., DCI, PDCCH). Which result(s)/parameters to be used for AI/ML output may be configured/indicated by a common/dedicated/UE-specific RRC message/signaling and/or SI and/or indicated by L2 signaling (e.g., MAC CE) and/or L1 signaling (e.g., DCI, PDCCH).

### AI/ML for Positioning Accuracy Enhancement

Whether to support AI/ML for positioning accuracy enhancement 770 or not may be a UE capability. A capability signaling may comprise a parameter which indicates whether the UE 760 supports AI/ML for positioning accuracy enhancement 770. Whether to apply/use/implement AI/ML for positioning accuracy enhancement or not may be configured/indicated by a common/dedicated/UE-specific RRC message/signaling and/or SI and/or indicated by L2 signaling (e.g., MAC CE) and/or L1 signaling (e.g., DCI, PDCCH).

Whether to support direct AI/ML positioning or not may be a UE capability. A capability signaling may comprise a parameter which indicates whether the UE supports direct AI/ML positioning. Whether to apply/use/implement direct AI/ML positioning or not may be configured/indicated by a common/dedicated/UE-specific RRC message/signaling and/or SI and/or indicated by L2 signaling (e.g., MAC CE) and/or L1 signaling (e.g., DCI, PDCCH).

Whether to support AI/ML assisted positioning or not may be a UE capability. A capability signaling may comprise a parameter which indicates whether the UE supports AI/ML assisted positioning. Whether to apply/use/implement AI/ML assisted positioning or not may be configured/indicated by a common/dedicated/UE-specific RRC message/signaling and/or SI and/or indicated by L2 signaling (e.g., MAC CE) and/or L1 signaling (e.g., DCI, PDCCH).

Whether to support one-sided (AI/ML) model for positioning accuracy enhancement 770 (direct AI/ML positioning and/or AI/ML assisted positioning) or not may be a UE capability. A capability signaling may comprise a parameter which indicates whether the UE supports one-sided (AI/ML) model for positioning accuracy enhancement (direct AI/ML positioning and/or AI/ML assisted positioning). Whether to apply/use/implement one-sided (AI/ML) model for positioning accuracy enhancement 770 (direct AI/ML positioning and/or AI/ML assisted positioning) or not may be configured/indicated by a common/dedicated/UE-specific RRC message/signaling and/or SI and/or indicated by L2 signaling (e.g., MAC CE) and/or L1 signaling (e.g., DCI, PDCCH).

Whether to support two-sided (AI/ML) model for positioning accuracy enhancement (direct AI/ML positioning and/or AI/ML assisted positioning) or not may be a UE capability. A capability signaling may comprise a parameter which indicates whether the UE supports two-sided (AI/ML) model for positioning accuracy enhancement 770 (direct AI/ML positioning and/or AI/ML assisted positioning). Whether to apply/use/implement two-sided (AI/ML) model for positioning accuracy enhancement 770 (direct AI/ML positioning and/or AI/ML assisted positioning) or not may be configured/indicated by a common/dedicated/UE-specific RRC message/signaling and/or SI and/or indicated by L2 signaling (e.g., MAC CE) and/or L1 signaling (e.g., DCI, PDCCH).

Whether to support AI/ML for positioning accuracy enhancement 770 (direct AI/ML positioning and/or AI/ML assisted positioning) with or without network-UE collaboration may be a UE capability. A capability signaling may comprise a parameter which indicates whether the UE supports AI/ML for positioning accuracy enhancement 770 (direct AI/ML positioning and/or AI/ML assisted positioning) with or without network-UE collaboration. Whether to apply/use/implement AI/ML for positioning accuracy enhancement (direct AI/ML positioning and/or AI/ML assisted positioning) with or without network-UE collaboration may be configured/indicated by a common/dedicated/UE-specific RRC message/signaling and/or SI and/or indicated by L2 signaling (e.g., MAC CE) and/or L1 signaling (e.g., DCI, PDCCH).

Whether to support AI/ML for positioning accuracy enhancement 770 (direct AI/ML positioning and/or AI/ML assisted positioning) with network-UE collaboration level y (i.e., signaling-based collaboration without model transfer) or not may be a UE capability. A capability signaling may comprise a parameter which indicates whether the UE supports AI/ML for positioning accuracy enhancement 770 (direct AI/ML positioning and/or AI/ML assisted positioning) with network-UE collaboration level y (i.e., signaling-based collaboration without model transfer) or not. Whether to apply/use/implement AI/ML for positioning accuracy enhancement 770 (direct AI/ML positioning and/or AI/ML assisted positioning) with network-UE collaboration level y (i.e., signaling-based collaboration without model transfer) or not may be configured/indicated by a common/dedicated/UE-specific RRC message/signaling and/or SI and/or indicated by L2 signaling (e.g., MAC CE) and/or L1 signaling (e.g., DCI, PDCCH).

Whether to support AI/ML for positioning accuracy enhancement 770 (direct AI/ML positioning and/or AI/ML assisted positioning) with network-UE collaboration level z (i.e., signaling-based collaboration with model transfer) or not may be a UE capability. A capability signaling may comprise a parameter which indicates whether the UE supports AI/ML for positioning accuracy enhancement 770 (direct AI/ML positioning and/or AI/ML assisted positioning) with network-UE collaboration level z (i.e., signaling-based collaboration with model transfer) or not. Whether to apply/use/implement AI/ML for positioning accuracy enhancement 770 (direct AI/ML positioning and/or AI/ML assisted positioning) with network-UE collaboration level z (i.e., signaling-based collaboration with model transfer) or not may be configured/indicated by a common/dedicated/UE-specific RRC message/signaling and/or SI and/or indicated by L2 signaling (e.g., MAC CE) and/or L1 signaling (e.g., DCI, PDCCH). A maximum number of AI/ML model units 764 (e.g., memory storage(s) for AI/ML model(s), AI/ML model size(s), AI/ML parameter payload size(s), AI/ML model parameter(s)) for positioning accuracy enhancement (direct AI/ML positioning and/or AI/ML assisted positioning) may be a UE capability. A capability signaling (e.g., positioningFramework, positioningFrameworkExt-AIML) may comprise a parameter (e.g., simultaneouspositioning-AIML) which indicates the number of AI/ML model units (e.g., memory storage(s) for AI/ML model(s), AI/ML model size(s), AI/ML parameter payload size(s), AI/ML model parameter(s)) for which the UE can implement/apply/use/store simultaneously for which this capability is provided. Whether to apply/use/implement the maximum number of AI/ML model units 764 (e.g., memory storage(s) for AI/ML model(s), AI/ML model size(s), AI/ML parameter payload size(s), AI/ML model parameter(s)) for positioning accuracy enhancement (direct AI/ML positioning and/or AI/ML assisted positioning) may be configured/indicated by a common/dedicated/UE-specific RRC message/signaling and/or SI and/or indicated by L2 signaling (e.g., MAC CE) and/or L1 signaling (e.g., DCI, PDCCH).

For direct AI/ML positioning, the output of AI/ML model inference is UE location. For example, fingerprinting based on channel observation may be used as the input of AI/ML model. The channel observation as the input of AI/ML model may be CIR, RSRP, angle(s) of link(s) and/or other types of channel observation. Which observation(s)/result(s)/parameter(s) to be used for AI/ML input may be configured/indicated by a common/dedicated/UE-specific RRC message/signaling and/or SI and/or indicated by L2 signaling (e.g., MAC CE) and/or L1 signaling (e.g., DCI, PDCCH).

For AI/ML assisted positioning, the output of AI/ML model inference is new measurement and/or enhancement of existing measurement. The output of AI/ML model inference may be LOS/NLOS identification, timing and/or angle of measurement, likelihood of measurement. Which measurement(s)/result(s)/parameter(s) to be used for AI/ML output may be configured/indicated by a common/dedicated/UE-specific RRC message/signaling and/or SI and/or indicated by L2 signaling (e.g., MAC CE) and/or L1 signaling (e.g., DCI, PDCCH).

Location reporting may be supported for AI/ML assisted positioning (e.g., data collection, AI/ML model training).

For example, aperiodic location reporting on the PUSCH (e.g., the aperiodic location report (e.g., the aperiodic location report transmitted together with the uplink data on the PUSCH)) may be considered as the same as the uplink data transmission on the PUSCH (e.g., the UL-SCH transmission). For example, the gNB may transmit the DCI format(s) which triggers a trigger state (e.g., an aperiodic location trigger state, the aperiodic location report). And, the UE 760 may perform the aperiodic location reporting on the PUSCH based on a decoding (e.g., detecting, receiving) the DCI format(s) which triggers the trigger state. Here, the trigger state is initiated (e.g., indicated) by using the location request field in the DCI format(s). Namely, the gNB may transmit the DCI format(s) including the location request field set to trigger the aperiodic location report. And, the UE may perform the aperiodic location reporting on the PUSCH based on the decoding of the DCI format(s) including the location request field set to trigger the aperiodic location report.

Additionally or alternatively, the gNB may transmit, by using the RRC message, information on a configuration(s) for the semi-persistent location reporting(s) (e.g., and/or a configuration(s) for the semi-persistent location related parameters/configurations). Also, the gNB may transmit the DCI format(s) which activates a semipersistent location trigger state(s). For example, the DCI format(s) for the uplink may include the location request field which indicates the semi-persistent location trigger state(s) to activate or deactivate. And, based on a decoding of the DCI format(s) (e.g., the DCI format(s) for the uplink) which activates the semi-persistent location trigger state(s), the UE may perform the semi-persistent location reporting(s) on the PUSCH based on the configuration(s) of the semi-persistent location reporting(s). Namely, the gNB may transmit the DCI format(s) (e.g., the DCI format(s) for the uplink) including the location request set to activate the semi-persistent report(s). And, based on the decoding of the DCI format(s) (e.g., the DCI format(s)) including the location request field set to activate the semi-persistent location report(s), the UE may perform the semi-persistent location reporting(s) on the PUSCH according the configuration(s) of the semi-persistent scheduling(s).

Additionally or alternatively, the gNB may transmit, by using the RRC message, information on a configuration(s) for the periodic location reporting(s) (e.g., and/or a configuration(s) for a periodic location related parameters/configurations). And, the UE may perform the periodic location reporting(s) on the PUCCH based on the configuration(s) of the periodic location reporting(s). Here, in a case that the UE would transmit the PUSCH that overlaps with the PUCCH that includes the periodic location report(s), the UE may perform the periodic location reporting(s) on the PUSCH. Namely, in the case that the UE would perform the PUSCH transmission(s) that overlaps with the periodic location reporting(s) on the PUCCH, the UE may perform the periodic location reporting(s) on the PUSCH.

Model reporting may be supported for AI/ML assisted positioning (AI/ML for CSI feedback enhancement, AI/ML for beam management, or other use cases). UE may reports it local AI/ML model and/or model updates to gNB periodically, semi-persistently, and/or aperiodically.

For example, aperiodic model reporting on the PUSCH (e.g., the aperiodic model report (e.g., the aperiodic model report transmitted together with the uplink data on the PUSCH)) may be considered as the same as the uplink data transmission on the PUSCH (e.g., the UL-SCH transmission). For example, the gNB may transmit the DCI format(s) which triggers a trigger state (e.g., an aperiodic model trigger state, the aperiodic model report). And, the UE may perform the aperiodic model reporting on the PUSCH based on a decoding (e.g., detecting, receiving) the DCI format(s) which triggers the trigger state. Here, the trigger state is initiated (e.g., indicated) by using the model request field in the DCI format(s). Namely, the gNB may transmit the DCI format(s) including the model request field set to trigger the aperiodic model report. And, the UE may perform the aperiodic model reporting on the PUSCH based on the decoding of the DCI format(s) including the model request field set to trigger the aperiodic model report.

Additionally or alternatively, the gNB may transmit, by using the RRC message, information on a configuration(s) for the semi-persistent model reporting(s) (e.g., and/or a configuration(s) for the semi-persistent model related parameters/configurations). Also, the gNB may transmit the DCI format(s) which activates a semi-persistent model trigger state(s). For example, the DCI format(s) for the uplink may include the model request field which indicates the semi-persistent model trigger state(s) to activate or deactivate. And, based on a decoding of the DCI format(s) (e.g., the DCI format(s) for the uplink) which activates the semi-persistent model trigger state(s), the UE may perform the semi-persistent model reporting(s) on the PUSCH based on the configuration(s) of the semi-persistent model reporting(s). Namely, the gNB may transmit the DCI format(s) (e.g., the DCI format(s) for the uplink) including the model request set to activate the semi-persistent report(s). And, based on the decoding of the DCI format(s) (e.g., the DCI format(s)) including the model request field set to activate the semi-persistent model report(s), the UE may perform the semi-persistent model reporting(s) on the PUSCH according the configuration(s) of the semi-persistent scheduling(s).

Additionally or alternatively, the gNB may transmit, by using the RRC message, information on a configuration(s) for the periodic model reporting(s) (e.g., and/or a configuration(s) for a periodic model related parameters/configurations). And, the UE may perform the periodic model reporting(s) on the PUCCH based on the configuration(s) of the periodic model reporting(s). Here, in a case that the UE would transmit the PUSCH that overlaps with the PUCCH that includes the periodic model report(s), the UE may perform the periodic model reporting(s) on the PUSCH. Namely, in the case that the UE would perform the PUSCH transmission(s) that overlaps with the periodic model reporting(s) on the PUCCH, the UE may perform the periodic model reporting(s) on the PUSCH.

After receiving location report(s) and model report(s) from UE, gNB may train/update AI/ML model(s). Then gNB may transfer the updated model(s) to UE by RRC message/signaling, L2 signaling (e.g., MAC CE), L1 signaling (e.g., PDCCH, DCI).

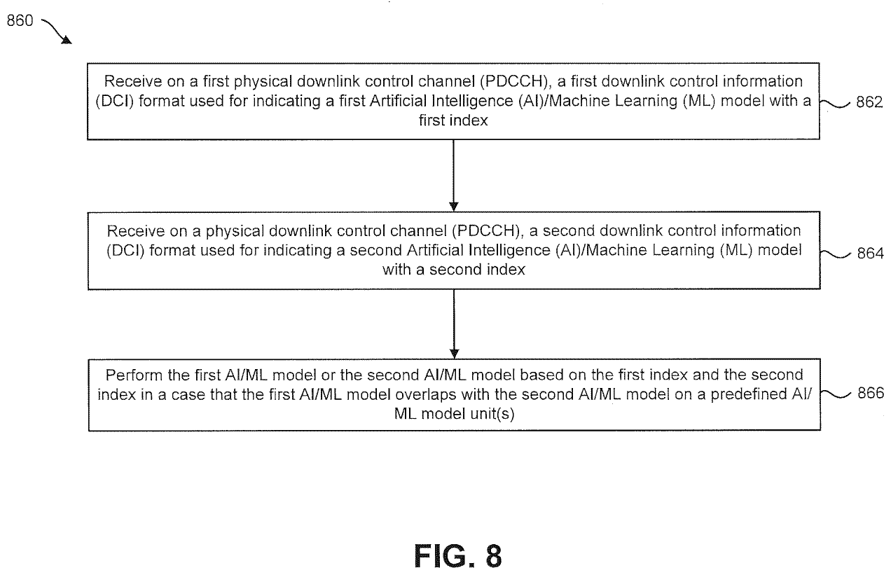

FIG. 8 is a flow diagram illustrating an example of a communication method 860 for a UE. The UE may receive 862 on a first physical downlink control channel (PDCCH), a first downlink control information (DCI) format used for indicating a first Artificial Intelligence (AI)/Machine Learning (ML) model with a first index. The UE may then receive 864 on a physical downlink control channel (PDCCH), a second downlink control information (DCI) format used for indicating a second Artificial Intelligence (AI)/Machine Learning (ML) model with a second index. The UE may then perform 866 the first AI/ML model or the second AI/ML model based on the first index and the second index in a case that the first AI/ML model overlaps with the second AI/ML model on a predefined AI/ML model unit(s).

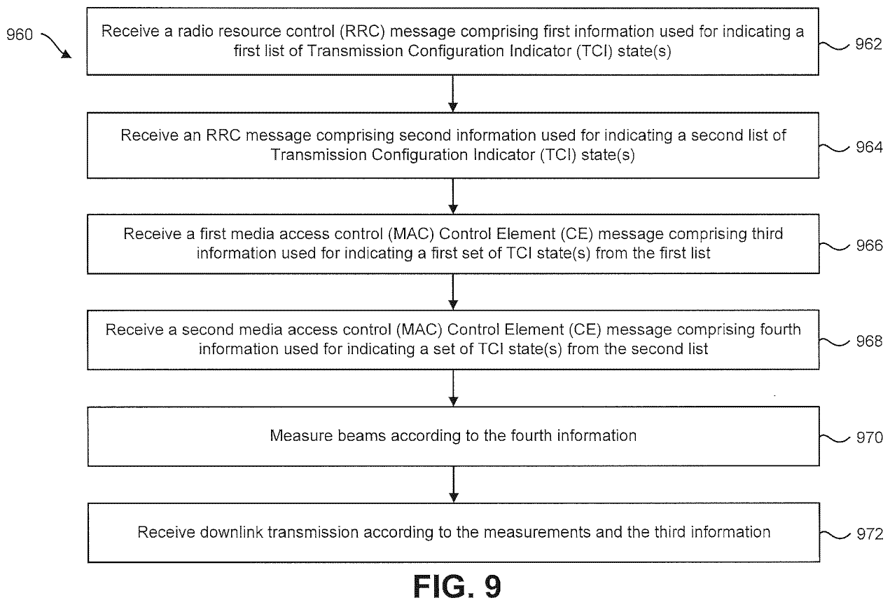

FIG. 9 is a flow diagram illustrating an example of a communication method 960 of a UE that communicates with a base station apparatus. The UE may receive 962 a radio resource control (RRC) message comprising first information used for indicating a first list of Transmission Configuration Indicator (TCI) state(s). The UE may then receive 964 an RRC message comprising second information used for indicating a second list of Transmission Configuration Indicator (TCI) state(s). The UE may then receive 966 a first media access control (MAC) Control Element (CE) message comprising third information used for indicating a first set of TCI state(s) from the first list. The UE may then receive 968 a second media access control (MAC) Control Element (CE) message comprising fourth information used for indicating a set of TCI state(s) from the second list. The UE may then measure 970 beams according to the fourth information. The UE may then receive 972 receive downlink transmission according to the measurements and the third information.

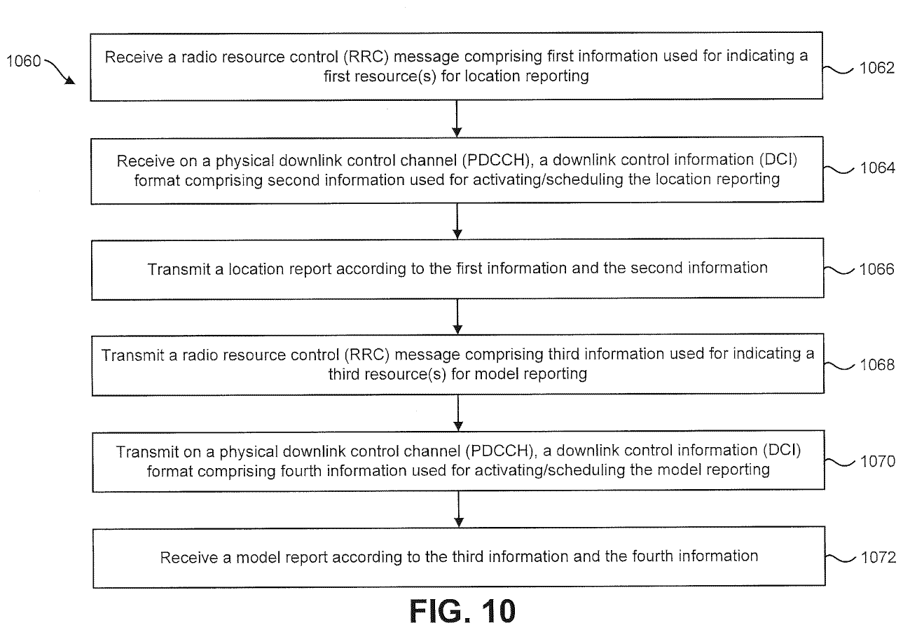

FIG. 10 is a flow diagram illustrating an example of a communication method 1060 of a UE that communicates with a base station apparatus. The UE may receive 1062 a radio resource control (RRC) message comprising first information used for indicating a first resource(s) for location reporting. The UE may then receive 1064 on a physical downlink control channel (PDCCH), a downlink control information (DCI) format comprising second information used for activating/scheduling the location reporting. The UE may then transmit 1066 a location report according to the first information and the second information. The UE may then transmit 1068 a radio resource control (RRC) message comprising third information used for indicating a third resource(s) for model reporting. The UE may then transmit 1070 on a physical downlink control channel (PDCCH), a downlink control information (DCI) format comprising fourth information used for activating/scheduling the model reporting. The UE may then receive 1072 a model report according to the third information and the fourth information.

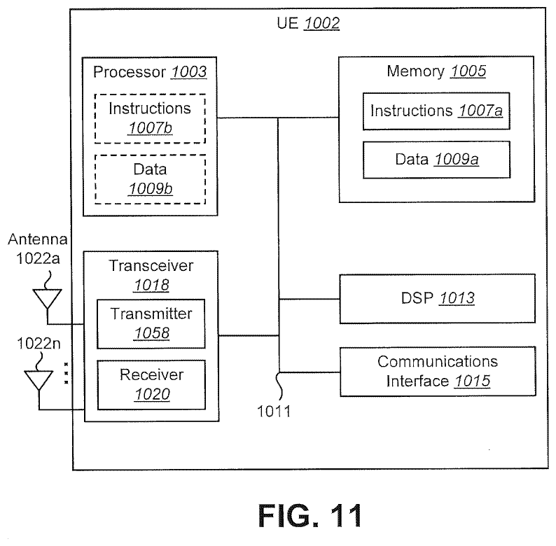

FIG. 11 illustrates various components that may be utilized in a UE 1002. The UE 1002 described in connection with FIG. 11 may be implemented in accordance with the UE 102 described in connection with FIG. 1. The UE 1002 includes a processor 1003 that controls operation of the UE 1002. The processor 1003 may also be referred to as a central processing unit (CPU). Memory 1005, which may include read-only memory (ROM), random access memory (RAM), a combination of the two or any type of device that may store information, provides instructions 1007a and data 1009a to the processor 1003. A portion of the memory 1005 may also include non-volatile random access memory (NVRAM). Instructions 1007b and data 1009b may also reside in the processor 1003. Instructions 1007b and/or data 1009b loaded into the processor 1003 may also include instructions 1007a and/or data 1009a from memory 1005 that were loaded for execution or processing by the processor 1003. The instructions 1007b may be executed by the processor 1003 to implement the methods described herein.

The UE 1002 may also include a housing that contains one or more transmitters 1058 and one or more receivers 1020 to allow transmission and reception of data. The transmitter(s) 1058 and receiver(s) 1020 may be combined into one or more transceivers 1018. One or more antennas 1022a-n are attached to the housing and electrically coupled to the transceiver 1018.

The various components of the UE 1002 are coupled together by a bus system 1011, which may include a power bus, a control signal bus and a status signal bus, in addition to a data bus. However, for the sake of clarity, the various buses are illustrated in FIG. 11 as the bus system 1011. The UE 1002 may also include a digital signal processor (DSP) 1013 for use in processing signals. The UE 1002 may also include a communications interface 1015 that provides user access to the functions of the UE 1002. The UE 1002 illustrated in FIG. 11 is a functional block diagram rather than a listing of specific components.

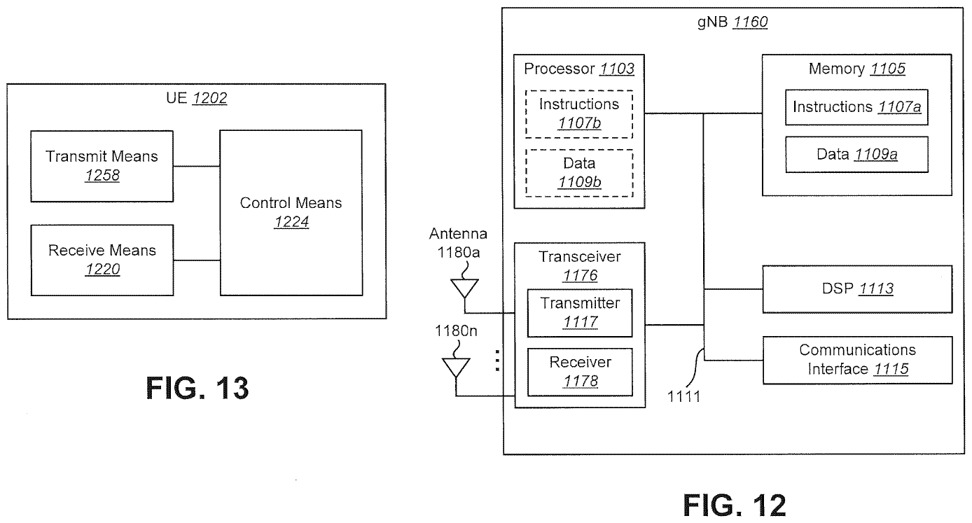

FIG. 12 illustrates various components that may be utilized in a gNB 1160. The gNB 1160 described in connection with FIG. 12 may be implemented in accordance with the gNB 160 described in connection with FIG. 1. The gNB 1160 includes a processor 1103 that controls operation of the gNB 1160. The processor 1103 may also be referred to as a central processing unit (CPU). Memory 1105, which may include read-only memory (ROM), random access memory (RAM), a combination of the two or any type of device that may store information, provides instructions 1107a and data 1109a to the processor 1103. A portion of the memory 1105 may also include nonvolatile random access memory (NVRAM). Instructions 1107b and data 1109b may also reside in the processor 1103. Instructions 1107b and/or data 1109b loaded into the processor 1103 may also include instructions 1107a and/or data 1109a from memory 1105 that were loaded for execution or processing by the processor 1103. The instructions 1107b may be executed by the processor 1103 to implement the methods described herein.

The gNB 1160 may also include a housing that contains one or more transmitters 1117 and one or more receivers 1178 to allow transmission and reception of data. The transmitter(s) 1117 and receiver(s) 1178 may be combined into one or more transceivers 1176. One or more antennas 1180a-n are attached to the housing and electrically coupled to the transceiver 1176.

The various components of the gNB 1160 are coupled together by a bus system 1111, which may include a power bus, a control signal bus and a status signal bus, in addition to a data bus. However, for the sake of clarity, the various buses are illustrated in FIG. 12 as the bus system 1111. The gNB 1160 may also include a digital signal processor (DSP) 1113 for use in processing signals. The gNB 1160 may also include a communications interface 1115 that provides user access to the functions of the gNB 1160. The gNB 1160 illustrated in FIG. 12 is a functional block diagram rather than a listing of specific components.

FIG. 13 is a block diagram illustrating one implementation of a UE 1202 in which one or more of the systems and/or methods described herein may be implemented. The UE 1202 includes transmit means 1258, receive means 1220 and control means 1224. The transmit means 1258, receive means 1220 and control means 1224 may be configured to perform one or more of the functions described in connection with FIG. 1 above. Various structures may be implemented to realize one or more of the functions of FIG. 1. For example, a DSP may be realized by software.

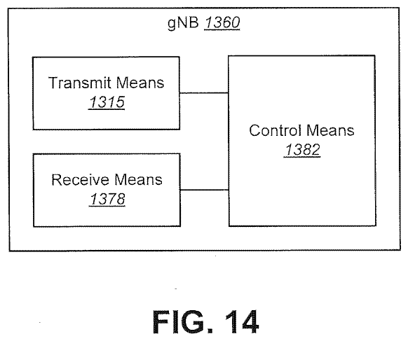

FIG. 14 is a block diagram illustrating one implementation of a gNB 1360 in which one or more of the systems and/or methods described herein may be implemented. The gNB 1360 includes transmit means 1315, receive means 1378 and control means 1382. The transmit means 1315, receive means 1378 and control means 1382 may be configured to perform one or more of the functions described in connection with FIG. 1 above. Various structures may be implemented to realize one or more of the functions of FIG. 1. For example, a DSP may be realized by software.

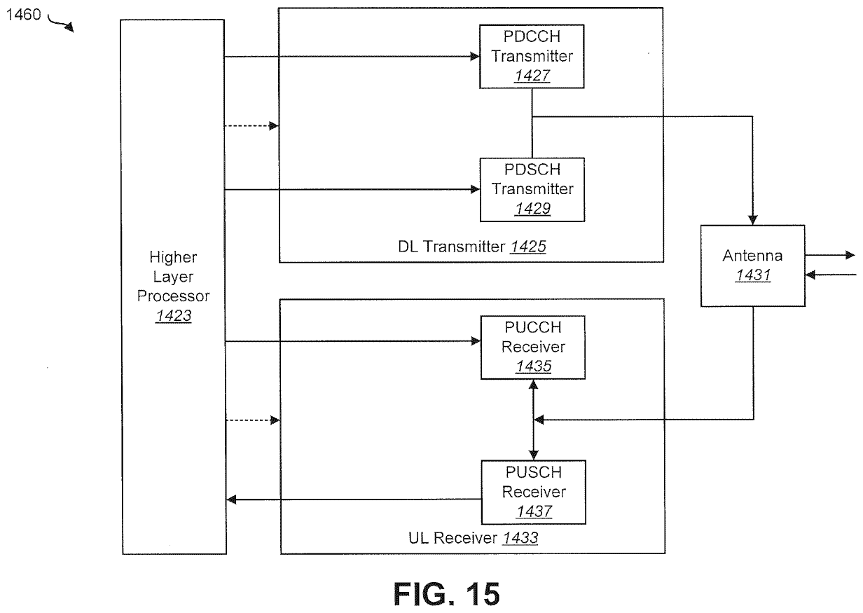

FIG. 15 is a block diagram illustrating one implementation of a gNB 1460. The gNB 1460 may be an example of the gNB 160 described in connection with FIG. 1. The gNB 1460 may include a higher layer processor 1423, a DL transmitter 1425, a UL receiver 1433, and one or more antenna 1431. The DL transmitter 1425 may include a PDCCH transmitter 1427 and a PDSCH transmitter 1429. The UL receiver 1433 may include a PUCCH receiver 1435 and a PUSCH receiver 1437.

The higher layer processor 1423 may manage physical layer's behaviors (the DL transmitter's and the UL receiver's behaviors) and provide higher layer parameters to the physical layer. The higher layer processor 1423 may obtain transport blocks from the physical layer. The higher layer processor 1423 may send/acquire higher layer messages such as an RRC message and MAC message to/from a UE's higher layer. The higher layer processor 1423 may provide the PDSCH transmitter transport blocks and provide the PDCCH transmitter transmission parameters related to the transport blocks.

The DL transmitter 1425 may multiplex downlink physical channels and downlink physical signals (including reservation signal) and transmit them via transmission antennas 1431. The UL receiver 1433 may receive multiplexed uplink physical channels and uplink physical signals via receiving antennas 1431 and de-multiplex them. The PUCCH receiver 1435 may provide the higher layer processor 1423 UCI. The PUSCH receiver 1437 may provide the higher layer processor 1423 received transport blocks.

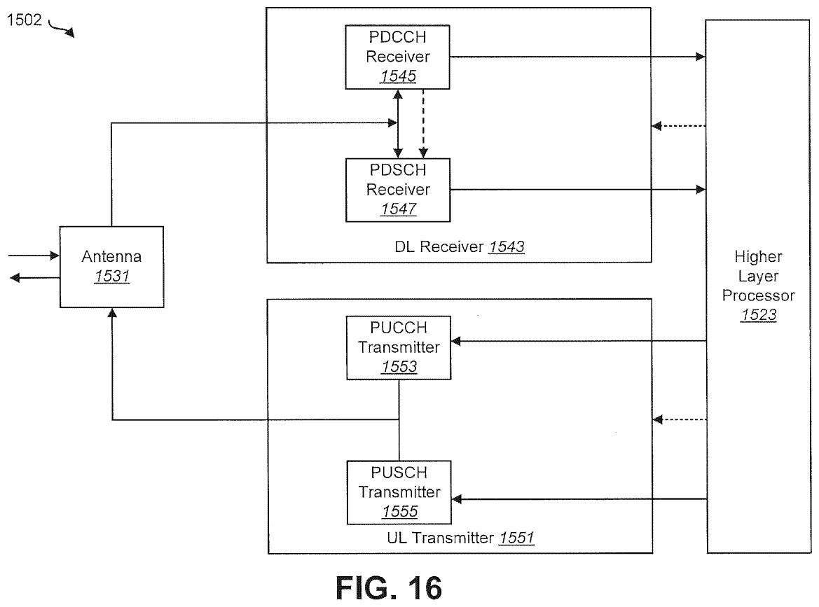

FIG. 16 is a block diagram illustrating one implementation of a UE 1502. The UE 1502 may be an example of the UE 102 described in connection with FIG. 1. The UE 1502 may include a higher layer processor 1523, a UL transmitter 1551, a DL receiver 1543, and one or more antenna 1531. The UL transmitter 1551 may include a PUCCH transmitter 1553 and a PUSCH transmitter 1555. The DL receiver 1543 may include a PDCCH receiver 1545 and a PDSCH receiver 1547.

The higher layer processor 1523 may manage physical layer's behaviors (the UL transmitter's and the DL receiver's behaviors) and provide higher layer parameters to the physical layer. The higher layer processor 1523 may obtain transport blocks from the physical layer. The higher layer processor 1523 may send/acquire higher layer messages such as an RRC message and MAC message to/from a UE's higher layer. The higher layer processor 1523 may provide the PUSCH transmitter transport blocks and provide the PUCCH transmitter 1553 UCI.

The DL receiver 1543 may receive multiplexed downlink physical channels and downlink physical signals via receiving antennas 1531 and de-multiplex them. The PDCCH receiver 1545 may provide the higher layer processor 1523 DCI. The PDSCH receiver 1547 may provide the higher layer processor 1523 received transport blocks.

The term “computer-readable medium” refers to any available medium that can be accessed by a computer or a processor. The term “computer-readable medium,” as used herein, may denote a computer- and/or processor-readable medium that is nontransitory and tangible. By way of example and not limitation, a computer-readable or processor-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer or processor. Disk and disc, as used herein, includes compact disc (CD), laser disc, optical disc, digital versatile disc (DVD), floppy disk and Blu-ray (Registered Trademark) disc where disks usually reproduce data magnetically, while discs reproduce data optically with lasers.

It should be noted that one or more of the methods described herein may be implemented in and/or performed using hardware. For example, one or more of the methods described herein may be implemented in and/or realized using a chipset, an application-specific integrated circuit (ASIC), a large-scale integrated circuit (LSI) or integrated circuit, etc.

Each of the methods disclosed herein comprises one or more steps or actions for achieving the described method. The method steps and/or actions may be interchanged with one another and/or combined into a single step without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods and apparatus described herein without departing from the scope of the claims.

A program running on the gNB 160 or the UE 102 according to the described systems and methods is a program (a program for causing a computer to operate) that controls a CPU and the like in such a manner as to realize the function according to the described systems and methods. Then, the information that is handled in these apparatuses is temporarily stored in a RAM while being processed. Thereafter, the information is stored in various ROMs or HDDs, and whenever necessary, is read by the CPU to be modified or written. As a recording medium on which the program is stored, among a semiconductor (for example, a ROM, a nonvolatile memory card, and the like), an optical storage medium (for example, a DVD, a MO, a MD, a CD, a BD and the like), a magnetic storage medium (for example, a magnetic tape, a flexible disk and the like) and the like, any one may be possible. Furthermore, in some cases, the function according to the described systems and methods described herein is realized by running the loaded program, and in addition, the function according to the described systems and methods is realized in conjunction with an operating system or other application programs, based on an instruction from the program.

Furthermore, in a case where the programs are available on the market, the program stored on a portable recording medium can be distributed or the program can be transmitted to a server computer that connects through a network such as the Internet. In this case, a storage device in the server computer also is included. Furthermore, some or all of the gNB 160 and the UE 102 according to the systems and methods described herein may be realized as an LSI that is a typical integrated circuit. Each functional block of the gNB 160 and the UE 102 may be individually built into a chip, and some or all functional blocks may be integrated into a chip. Furthermore, a technique of the integrated circuit is not limited to the LSI, and an integrated circuit for the functional block may be realized with a dedicated circuit or a general-purpose processor. Furthermore, if with advances in a semiconductor technology, a technology of an integrated circuit that substitutes for the LSI appears, it is also possible to use an integrated circuit to which the technology applies.

Moreover, each functional block or various features of the base station device and the terminal device used in each of the aforementioned embodiments may be implemented or executed by a circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller, or a state machine. The general-purpose processor or each circuit described herein may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

As used herein, the term “and/or” should be interpreted to mean one or more items. For example, the phrase “A, B and/or C” should be interpreted to mean any of: only A, only B, only C, A and B (but not C), B and C (but not A), A and C (but not B), or all of A, B, and C. As used herein, the phrase “at least one of” should be interpreted to mean one or more items. For example, the phrase “at least one of A, B and C” or the phrase “at least one of A, B or C” should be interpreted to mean any of: only A, only B, only C, A and B (but not C), B and C (but not A), A and C (but not B), or all of A, B, and C. As used herein, the phrase “one or more of” should be interpreted to mean one or more items. For example, the phrase “one or more of A, B and C” or the phrase “one or more of A, B or C” should be interpreted to mean any of: only A, only B, only C, A and B (but not C), B and C (but not A), A and C (but not B), or all of A, B, and C.

1. A user equipment (UE) comprising:
receiving circuitry configured to receive on a first physical downlink control channel (PDCCH), a first downlink control information (DCI) format used for indicating a first Artificial Intelligence (AI)/Machine Learning (ML) model with a first index,
receiving circuitry configured to receive on a PDCCH a second DCI format used for indicating a second AI/ML model with a second index, and
processing circuitry configured to perform the first AI/ML model or the second AI/ML model based on the first index and the second index in a case that the first AI/ML model overlaps with the second AI/ML model on a predefined AI/ML model unit(s).

2. The UE of claim 1, wherein the receiving circuitry is configured to:
receive a radio resource control (RRC) message comprising first information used for indicating a maximum number of the predefined AI/ML model unit(s).

3. The UE of claim 1, wherein the first index is determined by a first use case where the first AI/ML model is applied and the second index is determined by a second use case where the second AI/ML model is applied.

4. The UE of claim 1, wherein the first index is determined by a first set of parameters within the first AI/ML model and the second index is determined by a second set of parameters within the second AI/ML model.

5. The UE of claim 1, wherein the first index is determined by a first size of the first AI/ML model and the second index is determined by a second size of the second AI/ML model.

6. A base station apparatus comprising:
transmitting circuitry configured to transmit on a first physical downlink control channel (PDCCH), a first downlink control information (DCI) format used for indicating a first Artificial Intelligence (AI)/Machine Learning (ML) model with a first index, and
transmitting circuitry configured to transmit on a PDCCH a second DCI format used for indicating a second AI/ML model with a second index.

7. The base station of claim 6, wherein the transmitting circuitry is configured to:
transmit a radio resource control (RRC) message comprising first information used for indicating a maximum number of the predefined AI/ML model unit(s).

8. The base station of claim 6, wherein the first index is determined by a first use case where the first AI/ML model is applied and the second index is determined by a second use case where the second AI/ML model is applied.

9. The base station of claim 6, wherein the first index is determined by a first set of parameters within the first AI/ML model and the second index is determined by a second set of parameters within the second AI/ML model.

10. The base station of claim 6, wherein the first index is determined by a first size of the first AI/ML model and the second index is determined by a second size of the second AI/ML model.

11. A communication method of a user equipment comprising:
receiving on a first physical downlink control channel (PDCCH), a first downlink control information (DCI) format used for indicating a first Artificial Intelligence (AI)/Machine Learning (ML) model with a first index,
receiving on a PDCCH a second DCI format used for indicating a second AI/ML model with a second index, and
performing the first AI/ML model or the second AI/ML model based on the first index and the second index in a case that the first AI/ML model overlaps with the second AI/ML model on a predefined AI/ML model unit(s).
